(19) United States
(12) Patent Application Publication
(10) Pub. No.: US 2008/0312099 A1
(43) Pub. Date: Dec. 18, 2008

(54) Microarray, System, and Method for Detecting, Identifying, and Quantitating Micro-Rnas

(75) Inventor: Eugenia Wang, Prospect, KY (US)

Correspondence Address: STITES & HARBISON, PLLC, 400 W MARKET ST, SUITE 1800, LOUISVILLE, KY, 40202-3352, US

(73) Assignee: UNIVERSITY OF LOUISVILLE RESEARCH FOUNDATION, INC., Louisville, KY (US)

(21) Appl. No.: 11/997,388

(22) PCT Filed: Feb. 15, 2007
(86) PCT No.: PCT/US07/62233

§ 371 Date: Jan. 30, 2008

Related U.S. Application Data
(60) Provisional application No. 60/773,559, filed on Feb. 15, 2006.

(51) Int. Cl. C40B 30/04; C40B 40/06

(52) U.S. Cl. 506/9; 506/16

(57) ABSTRACT

Micro-RNA (miRNA) microarrays useful for detecting, identifying and quantitating miRNAs in a sample include oligonucleotide probes that specifically bind miRNAs. Exemplary miRNA microarray can be specific for miRNAs of human, canine, mouse, rat, or another species.

### CROSS-REFERENCE TO RELATED APPLICATIONS

This application claims priority from U.S. Provisional Application Ser. No. 60/773,559 filed Feb. 15, 2006, the entire disclosure of which is incorporated herein by this reference.

### STATEMENT REGARDING FEDERALLY SPONSORED RESEARCH

This invention was made with United States government support under Grant Numbers NAG2-1647 and DAAD19-01-1-0450 awarded by National Aeronautics and Space Administration and Defense Advance Research Project Agency, respectively. The government has certain rights in the invention.

### FIELD OF THE INVENTION

The present invention relates to microRNAs, and, more particularly, to devices, systems, and methods for detecting, identifying, and quantitating microRNAs in a sample.

### BACKGROUND OF THE INVENTION

MicroRNAs (miRNAs) are naturally occurring, small non-coding RNAs that are about 17 to about 25 nucleotide bases (nt) in length in their biologically active form. miRNAs post-transcriptionally regulate gene expression by repressing target mRNA translation and degrading target mRNA. It is thought that miRNAs function as negative regulators, i.e. greater amounts of a specific miRNA will correlate with lower levels of target gene expression.

There are three forms of miRNAs existing in vivo, primary miRNAs (pri-miRNAs), premature miRNAs (pre-miRNAs), and mature miRNAs. Primary miRNAs (pri-miRNAs) are expressed as stem-loop structured transcripts of about a few hundred bases to over 1 kb. The pri-miRNA transcripts are cleaved in the nucleus by an RNase II endonuclease called Drosha that cleaves both strands of the stem near the base of the stem loop. Drosha cleaves the RNA duplex with staggered cuts, leaving a 5′phosphate and 2 nt overhang at the 3′ end. The cleavage product, the premature miRNA (pre-miRNA) is about 60 to about 110 nt long with a hairpin structure formed in fold-back manner. Pre-miRNA is transported from the nucleus to the cytoplasm by Ran-GTP and Exportin-5. Pre-miRNAs are processed further in the cytoplasm by another RNase II endonuclease called Dicer. Dicer recognizes the 5′ phosphate and 3′ overhang, and cleaves the loop off at the stem-loop junction to form miRNA duplexes. The miRNA duplex binds to RISC (RNA-induced silencing complex), where the antisense strand is preferentially degraded and the sense strand mature miRNA directs RISC to its target site. It is the mature miRNA that is the biologically active form of the miRNA, of about 17 to about 25 nt in length.

MicroRNAs function by engaging in base pairing perfect or imperfect) with specific sequences in their target genes' messages (mRNA). The miRNA degrades or represses translation of the mRNA, causing the target genes' expression to be post-transcriptionally down-regulated, repressed, or silenced. In animals, miRNAs do not necessarily have perfect homologies to their target sites, and partial homologies lead to translational repression, whereas in plants, where miRNAs tend to show complete homologies to the target sites, degradation of the message (mRNA) prevails.

miRNAs are widely distributed in the genome, dominate gene regulation, and actively participate in many physiological and pathological processes. For example, the regulatory modality of certain miRNAs is found to control cell proliferation, differentiation, and apoptosis; and abnormal miRNA profiles are associated with oncogenesis. Additionally, it is suggested that viral infection causes an increase in miRNAs targeted to silence “pro-cell survival” genes, and a decrease in miRNAs repressing genes associated with apoptosis (programmed cell death), thus tilting the balance towards gaining apoptosis signaling.

Thousands of messages (mRNA) are under this selection pressure by hundreds of miRNA species identified so far; this selection process is instrumental in dampening specific groups of gene expressions which, for example, may no longer be needed, to allow cells to channel their physiological program direction to a new pathway of gene expression. The miRNA-dependent dampening of target groups of gene expression is a robust and rapid regulation to allow cells to depart from an old, and transition to a new, program. A typical example of this is demonstrated during embryonic development, when a particular group of cells is directed to become unique specialized cell types such as neurons, cardiomyocytes, muscle, etc. Here, activation of unique miRNAs targeted to destabilize and thus repress non-neuronal gene expressions in essence allows their counterpart neuronal genes to gain the advantage, to become the dominant group of genes to be expressed, and thus chart the cells to become neurons. Similar scenarios occur with other cell types: cardiomyocytes, epithelial cells, etc.

It is thought that expression levels of roughly a third of human genes are regulated by miRNAs, and that the miRNA regulation of unique gene expressions is linked to the particular signaling pathway for each specific cell type. For example, the apoptosis signaling pathway may be dictated by a group of miRNAs targeted to destabilize pro-survival gene messages, allowing alternative pro-apoptosis genes to gain dominance and thus activate the death program. Another example is the control of cancer growth; a recent discovery has shown that miRNAs may also be essential in preventing cells from becoming neoplastic. For example, two oncogenes, cMyc and c-Ras, are found to share control by one miRNA species, whose expression is down-regulated in cancer. In other words, lack of this miRNA allows the unchecked expression of cMyc and cRas, thus permitting these two genes to become abundantly present in cancer cells, allowing them to acquire uncontrolled cell proliferating ability, and set the stage for neoplastic growth. Additionally, it has been reported that a miRNA mutation is responsible for a phenotype of muscularity in sheep of Belgian origin, suggesting that mutations associated with genetic disorders could be found in miRNAs, where no evidence of mutations have been found in promoter regions, coding areas, and slicing sites.

It is doubtful that a particular cellular state is controlled by a single signaling activity. It is more likely that a coordinated orchestration of multiple pathways serves to control a particular cellular state, wherein certain molecular “hubs” may be involved, which are functionally manipulated by hierarchical orders and redundancy of molecular control. Indeed, dozens of miRNAs may operate to ensure that these “hubs” can exert either major or minor functions in cells, by simply repressing the expression of either themselves or their functional opponents. Thus, one gene product may function as a major “hub” for one signaling pathway in one type of cell, and in another cell type, it may be a minor “hub”, or may not be used at all. MicroRNA control of “hub” gene expressions may then be an expedient mechanism to provide such versatility for various molecules to serve as either major or minor “hubs’, or not at all, for different types of cellular operational modalities.

Given the role of miRNAs in gene regulation, and in many physiological and pathological processes, information about their interactive modes and their expression patterns is desirable to obtain. Systems and methods of quantitating and identifying which groups of putative miRNAs are in operation in a particular cell type, or in association with a particular process or condition of interest, would provide information useful for understanding how each cellular state evolves and is maintained, and how dysfunctional maintenance is abetted by improper decreases or increases of unique sets of miRNAs to regulate the expression of key genes.

Microarray technique is a powerful tool applied in gene expression studies. The technique provides many genes with known sequence information as probes to find and hybridize with the complementary strands in a sample, e.g., sample extracted from cells, tissues, or another nucleotide-containing sample of interest. Data mining work is completed by bioinformatics, including scanning chips, signal acquisition, image processing, normalization, statistic treatment and data comparison as well as pathway analysis. As such, microarray can profile hundreds and thousands of genes simultaneously with high through-put performance. Microarray profiling analysis of mRNA expression has successfully provided valuable data for gene expression studies in basic research. And the technique has been further put into practice in the pharmaceutical industry and in clinical diagnosis. With increasing amounts of miRNA data becoming available, and with accumulating evidence of the importance of miRNA in gene regulation, microarray becomes a useful technique for high through-put miRNA studies.

Microarray techniques have been applied to miRNA study; however, available microarrays and microarray techniques for studying miRNAs have various drawbacks. For example, certain known microarrays include probes to a limited number of miRNAs, allowing for informational voids when conducting miRNA studies. For another example, certain known microarrays include probes to pre-miRNAs, rather than the biologically active mature miRNAs. For another example, certain microarrays require the use of radioactive labels. For another example, certain microarrays require the use of fluorescent-labeling methods, which require the use of expensive fluorescent detectors to collect information. For another example, certain microarrays techniques have limited sensitivity, accuracy, reproducibility, and reliability.

Accordingly, there is a need in the art for improved devices, systems, and methods for detecting, identifying, and quantitating microRNAs in a sample.

### BRIEF SUMMARY OF THE INVENTION

The invention meets the above-identified needs by providing devices, systems, and methods for directly studying biological active microRNAs (miRNAs). The present invention allows for the detection, identification, and quantitation of miRNAs, while minimizing informational voids, by providing options for the use of miRNA probes selected from a unique and expansive collection. The present invention further allows for safe and cost-efficient detection, identification, and quantitation of microRNAs by using an enzymatic end-labeling technique. The present invention further provides systems and methods for detecting, identifying, and quantitating microRNAs with improved sensitivity, accuracy, reproduciblity, and reliability.

The present invention includes micro-RNA microarrays or microchips (MMChips). The present invention further includes systems and methods for detecting, identifying, and quantitating micro-RNAs (miRNAs) in a sample.

Exemplary MMChips of the present invention include an organized assortment of oligonucleotide probes immobilized onto an appropriate platform. The oligonucleotide probes are each about 15 to about 28 nucleotide bases (nt) in length. Each probe selectively binds a miRNA in a sample. In certain embodiments, each probe of the MMChip selectively binds a biologically active mature miRNA in a sample.

An exemplary MMChip includes probes that each selectively bind a mature micro-RNA; and a platform, on which the probes are immobilized. In some embodiments, the probes can be probes for selectively binding human miRNA. With reference to FIG. 1A, human miRNAs include miRNAs having the sequences of SEQ ID NOS: 1-19. Human miRNAs further include miRNAs identified in FIG. 1B by micro-RNA identifiers (miRNA IDs), and also identified by the miRNA IDs in the Sanger Institute miRBase Sequence Database, Version 7.0. In some embodiments, the MMChip can include at least one probe that selectively binds a human micro-RNA selected from human micro-RNAs comprising sequences of SEQ ID NOS: 1-19. In some embodiments, the MMChip can include at least one probe that selectively binds a human micro-RNA selected from human micro-RNAs comprising sequences of SEQ ID NOS: 1-19, and at least one probe that that selectively binds a human micro-RNA selected from the human micro-RNAs identified in FIG. 1B. In some embodiments, the MMChip can include probes that selectively bind each of the human micro-RNAs comprising sequences of SEQ ID NOS: 1-19. In some embodiments, the MMChip can include probes that selectively bind each of the human micro-RNAs comprising sequences of SEQ ID NOS: 1-19, and at least one probe that that selectively binds a human micro-RNA selected from the human micro-RNAs identified in FIG. 1B. In some embodiments, the MMChip can include probes that selectively bind each of the human micro-RNAs comprising sequences of SEQ ID NOS: 1-19, and probes that selectively bind each of the human micro-RNAs identified in FIG. 1B. In some embodiments, the MMChip can include at least one probe that selectively binds a cDNA copy of a human miRNA, such as a cDNA copy of a human miRNA having a sequence according to SEQ ID NOS: 20-38 and/or a human cDNA copy of a human miRNA identified in FIG. 1B. In some embodiments, the MMChip can include at least one probe that is selected from probes comprising sequences of SEQ ID NOS: 39-57. In some embodiments, the MMChip can include at least one probe that is selected from probes comprising sequences of SEQ ID NOS: 39-57, and at least one probe comprising a sequence that is complementary to a human micro-RNA identified in FIG. 1B. In some embodiments, the MMChip can include each of the probes comprising sequences of SEQ ID NOS: 39-57. In some embodiments, the MMChip can include each of the probes comprising sequences of SEQ ID NOS: 39-57, and at least one probe comprising a sequence that is complementary to a human micro-RNA identified in FIG. 1B. In some embodiments, the MMChip can include each of the probes comprising sequences of SEQ ID NOS: 39-57, and probes comprising sequences that are complementary to each of the human micro-RNAs identified in FIG. 1B.

In some embodiments, the MMChip can include probes for selectively binding canine mi-RNA. With reference to FIG. 2, canine miRNAs include miRNAs having a sequence of SEQ ID NOS: 58-160. In some embodiments, the MMChip can include at least one probe that selectively binds a canine miRNA selected from the canine miRNAs comprising sequences of SEQ ID NOS: 58-160. In some embodiments, the MMChip can include probes that selectively bind each of the canine miRNAs comprising sequences of SEQ ID NOS: 58-160. In some embodiments, the MMChip can include at least one probe that selectively binds a cDNA copy of a canine miRNA, such as a cDNA copy of a canine miRNA having a sequence according to SEQ ID NOS: 161-263. In some embodiments, the MMChip can include at least one probe that is selected from probes comprising sequences of SEQ ID NOS: 264-366. In some embodiments, the MMChip can include each of the probes comprising sequences of SEQ ID NOS: 264-366.

In some embodiments, the MMChip can include probes for selectively binding mouse mi-RNA. With reference to FIG. 3, mouse miRNAs include miRNAs identified in FIG. 3 by micro-RNA identifiers (miRNA IDs), and also identified by the miRNA IDs in the Sanger Institute miRBase Sequence Database, Version 7.0 (Sanger Database). In some embodiments, the MMChip can include at least one probe that selectively binds a mouse miRNA selected from the mouse miRNAs identified in FIG. 3. In some embodiments, the MMChip can include probes that selectively bind each of the mouse micro-RNAs identified in FIG. 3. In some embodiments, the MMChip can include at least one probe that selectively binds a cDNA copy of a mouse miRNA, such as a cDNA copy of a mouse miRNA identified in FIG. 3. In some embodiments, the MMChip can include at least one probe comprising a sequence that is complementary to a mouse micro-RNA identified in FIG. 3. In some embodiments, the MMChip can include probes comprising sequences that are complementary to each of the mouse micro-RNAs identified in FIG. 3.

In some embodiments, the MMChip can include probes for selectively binding rat mi-RNA. With reference to FIG. 4, rat miRNAs include miRNAs identified in FIG. 4 by micro-RNA identifiers (miRNA IDs), and also identified by the miRNA IDs in the Sanger Institute miRBase Sequence Database, Version 7.0 (Sanger Database). In some embodiments, the MMChip can include at least one probe that selectively binds a rat miRNA selected from the rat miRNAs identified in FIG. 4. In some embodiments, the MMChip can include probes that selectively bind each of the rat micro-RNAs identified in FIG. 4. In some embodiments, the MMChip can include at least one probe that selectively binds a cDNA copy of a rat miRNA, such as a cDNA copy of a rat miRNA identified in FIG. 4. In some embodiments, the MMChip can include at least one probe comprising a sequence that is complementary to a rat micro-RNA identified in FIG. 4. In some embodiments, the MMChip can include probes comprising sequences that are complementary to each of the rat micro-RNAs identified in FIG. 4.

Exemplary MMChips can include one or more of the following controls: a randomly-generated sequence used as a negative control; an oligonucletide sequence derived from a housekeeping gene, used as a negative control for total RNA degradation; a randomly-generated sequence used as a positive control; and a series of dilutions of at least one positive control sequence used as saturation controls. In certain embodiments one or more positive control sequences are positioned on the MMChip to indicate orientation of the MMChip.

When a negative control is provided, it can be selected from SEQ ID NOS: 375-381. When an oligonucletide sequence derived from a housekeeping gene is provided, it can be selected from SEQ ID NOS: 382-389. When a positive control is provided, it can be selected from SEQ ID NOS: 367-374.

An exemplary method of the present invention includes providing a first MMChip made in accordance with the present invention; providing a first labeled miRNA sample; hybridizing said first labeled miRNA sample with said first array; and detecting the hybridized miRNAs. In certain embodiments, the method additionally includes providing a second MMChip made in accordance with the present invention; providing a second labeled miRNA sample; hybridizing said second labeled miRNA sample with said second array; detecting the hybridized miRNAs; and comparing the hybridized miRNAs of the first array to the hybridized miRNAs of the second array. In certain embodiments, the miRNA sample can be labeled with Digoxingenin (DIG) and hybridization can be detected using anti-DIG antibody.

### BRIEF DESCRIPTION OF THE DRAWINGS

FIGS. 1A and 1B are charts identifying human micro-RNAs and related sequences, where FIG. 1A includes nucleotide sequences of human miRNAs (SEQ ID NOS: 1-19) and related micro-RNA identifiers (miRNA IDs), nucleotide sequences of human miRNAs substituted with DNA bases (cDNA copies) (SEQ ID NOS: 20-38), and nucleotide sequences of exemplary probes (SEQ ID NOS: 39-57), and where FIG. 1B identifies further human miRNAs by miRNA IDs, which human miRNA sequences are identified by the miRNA ID in the Sanger Institute miRBase Sequence Database, Version 7.0 (Sanger Database).

FIG. 2 is a chart identifying canine micro-RNAs, including nucleotide sequences of canine miRNAs (SEQ ID NOS: 58-160) and related miRNA IDs, nucleotide sequences of cDNA copies of canine miRNAs (SEQ ID NOS: 161-263), and nucleotide sequences of exemplary probes (SEQ ID NOS: 264-366);

FIG. 3 is a chart identifying mouse miRNAs by miRNA IDs, which mouse miRNA sequences are identified by the miRNA ID in the Sanger Database;

FIG. 4 is a chart identifying rat miRNAs by miRNA IDs, which mouse miRNA sequences are identified by the miRNA ID in the Sanger Database;

FIG. 5 is a template for an exemplary human microRNA microarray (“MM Chip”), showing the relative placement of the included miRNA probes as identified by miRNA identifiers (miRNA IDs);

FIG. 6 is a template for another exemplary human MM Chip, showing the relative placement of the included miRNA probes as identified by miRNA IDs;

FIG. 7 is a template for an exemplary canine MM Chip, showing the relative placement of the included miRNA probes as identified by miRNA IDs;

FIG. 8 is a template for an exemplary mouse MM Chip, showing the relative placement of the included miRNA probes as identified by miRNA IDs;

FIG. 9 is a chart including nucleotide sequences of exemplary control probes (SEQ ID NOS: 367-389);

FIG. 10 is a flow chart illustrating the steps involved in an exemplary method practiced in accordance with the present invention;

FIG. 11 is a flow chart illustrating the steps involved in another exemplary method practiced in accordance with the present invention;

FIG. 12A-12F are images of exemplary human MM Chips that are part of a time course study, where the MM Chips were hybridized with miRNA samples isolated from human cells infected with influenza for 0 (FIG. 12A), 6 (FIG. 12B), 12 (FIG. 12C), 24 (FIG. 12D), 48 (FIG. 12E), and 72 hours (FIG. 12F);

FIG. 13 is a chart showing the treatment associated with the up- or down-regulation of miRNAs;

FIG. 14 contains images of exemplary human MM Chips hybridized with miRNAs isolated from 0 and 24 hours following infection with influenza with white arrows pointing to up-regulated miRNAs post-infection and black arrows pointing to those with decreased intensity; and

FIGS. 15A and 15B are images of exemplary canine MM Chips hybridized with DIG-labeled miRNA samples.

### DETAILED DESCRIPTION OF EXEMPLARY EMBODIMENTS OF THE INVENTION

The present invention includes a micro-RNA microarray or microchip (MMChip). The present invention further includes systems and methods for detecting, identifying, and quantitating micro-RNAs (miRNAs) in a sample.

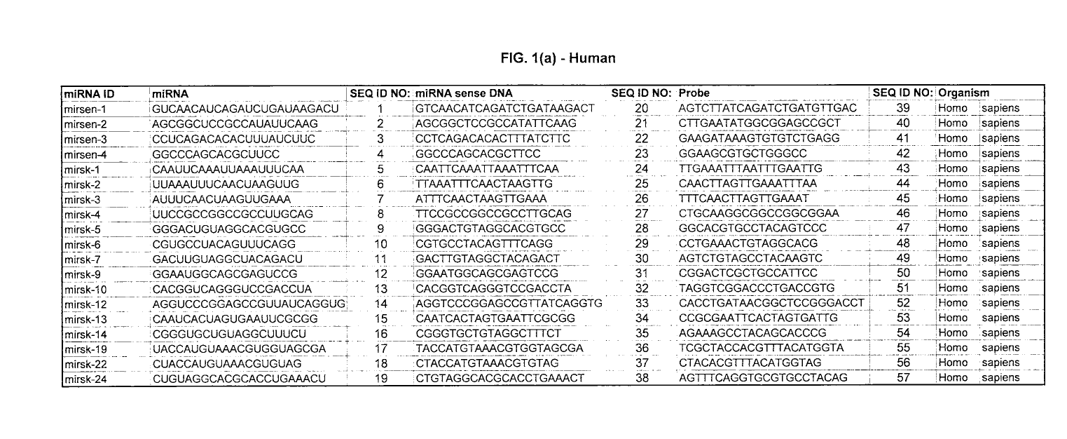

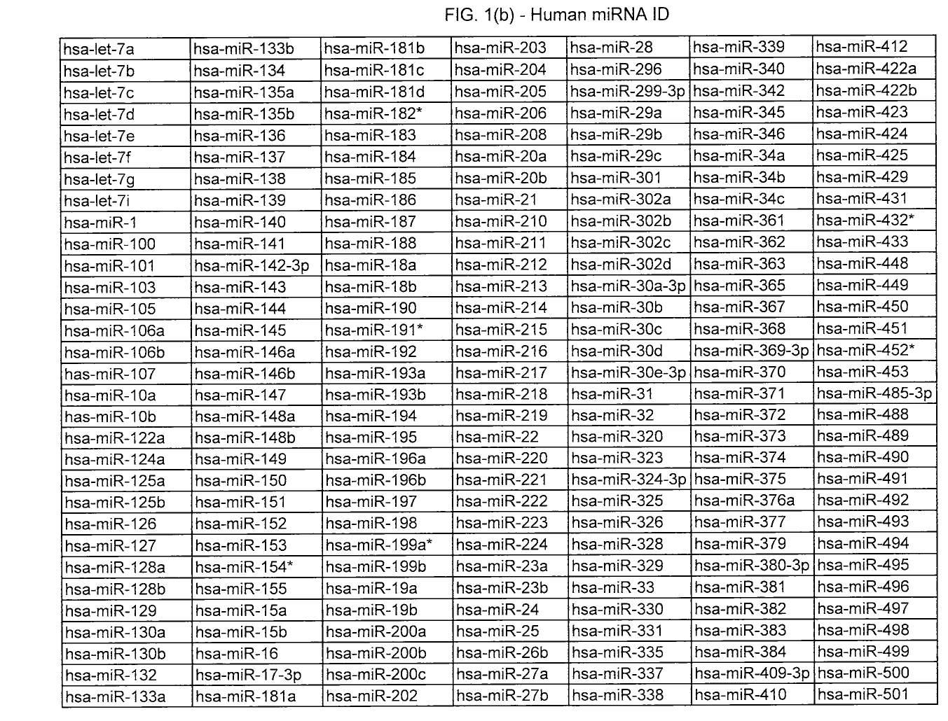

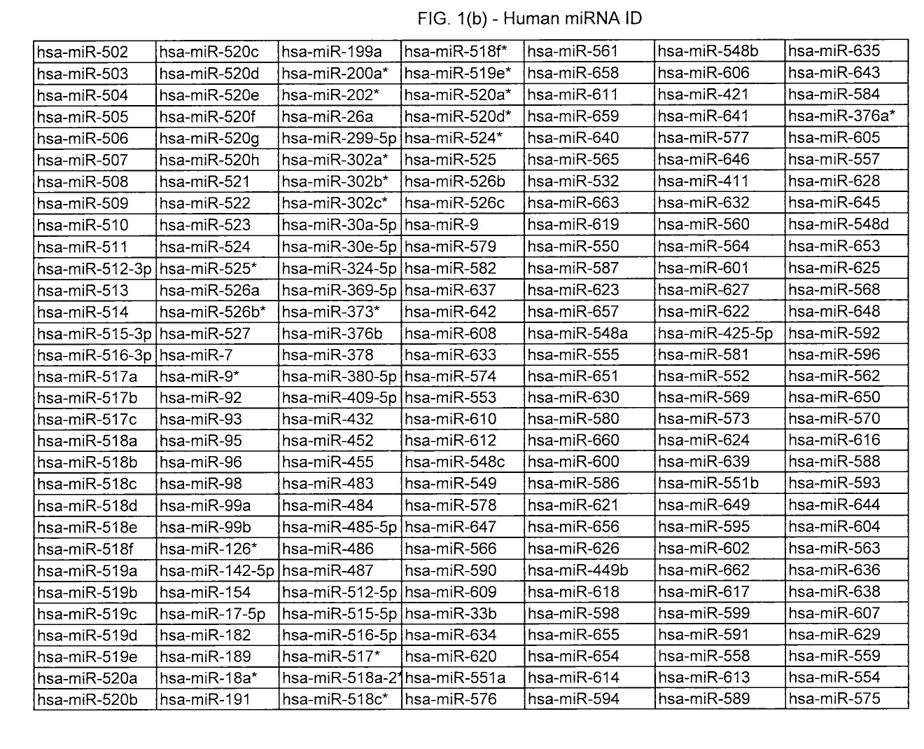

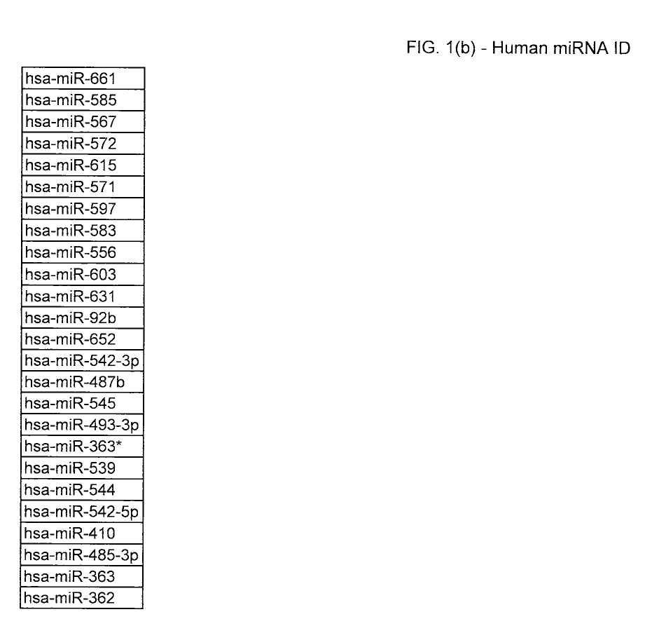

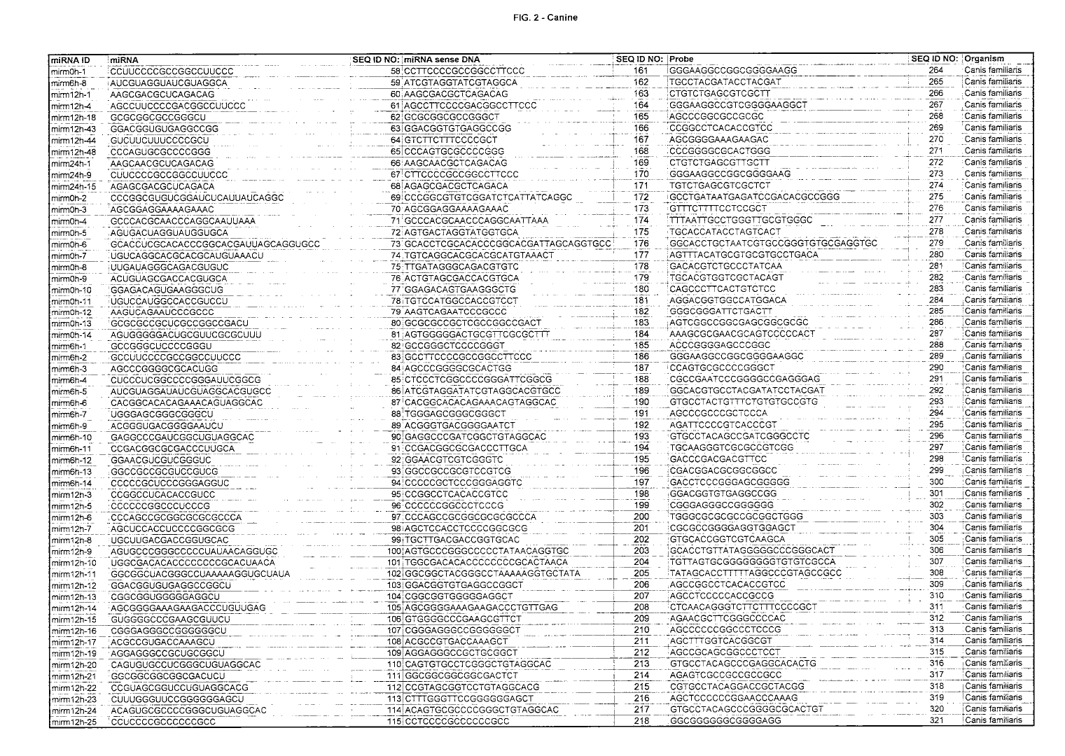

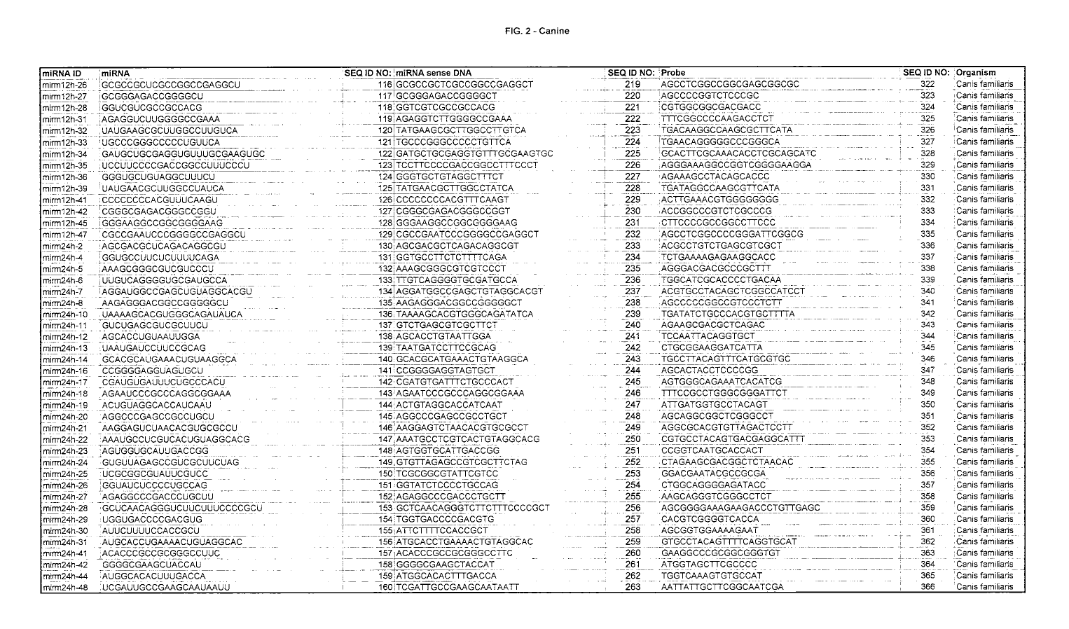

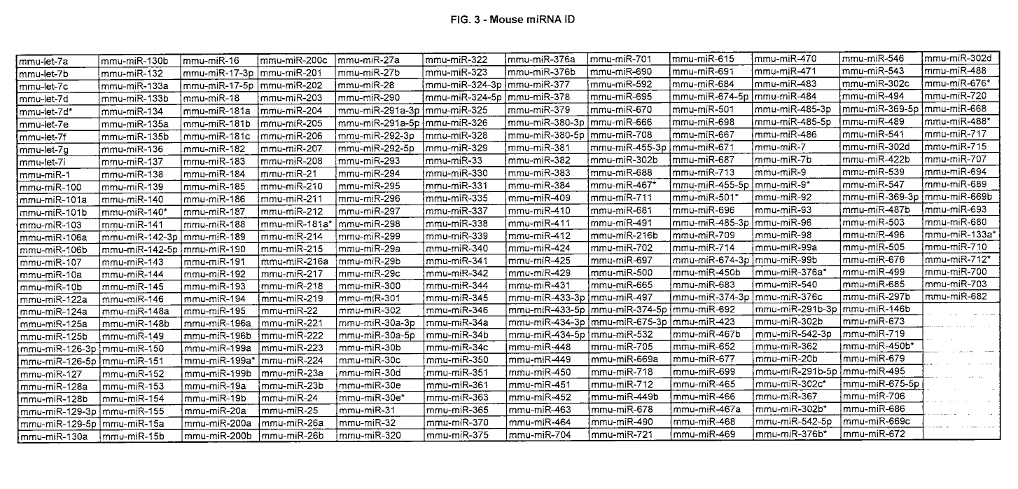

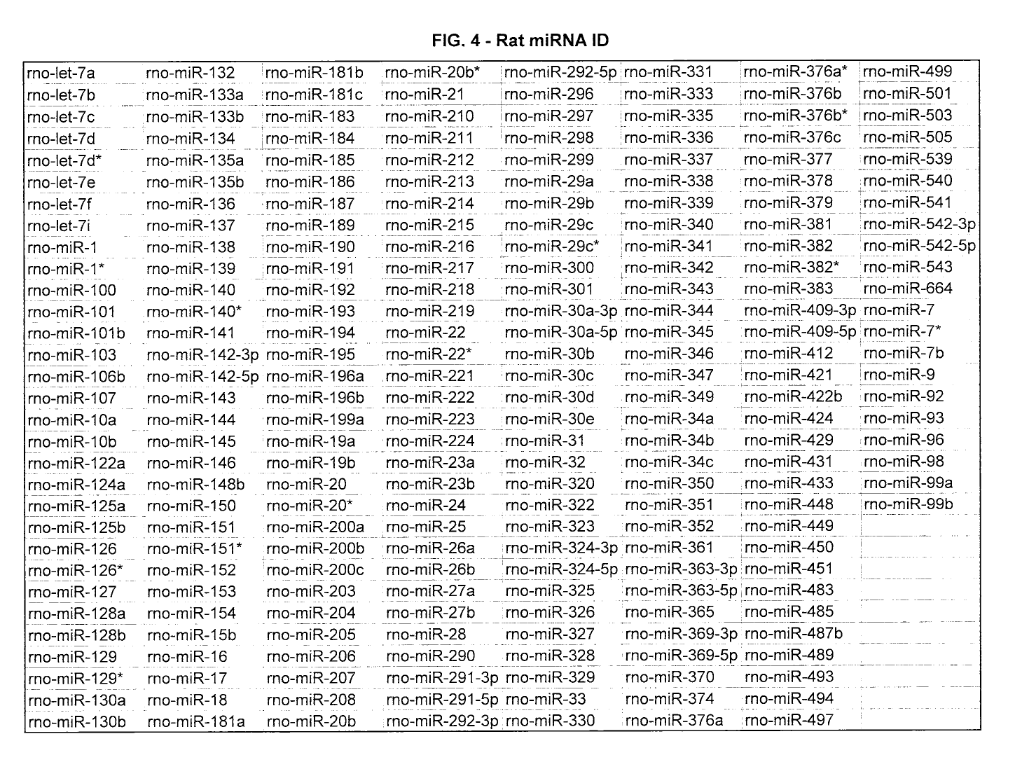

The Micro-RNA microarrays (MMChips), systems, and methods of the present invention are useful for detecting, identifying, and quantitating miRNAs in a sample. For example, the following miRNAs can be detected, identified, and quantitated in accordance with the present invention: human miRNAs having sequences according to SEQ ID NOS: 1-19, as set forth in FIG. 1A; human miRNAs identified by micro-RNA identifiers (miRNA IDs) from the Sanger Institute miRBase Sequence Database, Version 7.0 (Sanger Database), as set forth in FIG. 1B; canine miRNAs having sequences according to SEQ ID NOS: 58-160, as set forth in FIG. 2; mouse miRNAs identified by miRNA IDs from the Sanger Database, as set forth in FIG. 3; and rat miRNAs identified by miRNA IDs from the Sanger Database, as set forth in FIG. 4.

Exemplary MMChips of the present invention include an organized assortment of oligonucleotide probes immobilized onto an appropriate platform. The oligonucleotide probes are each about 15 to about 28 nucleotide bases (nt) in length. Each probe selectively binds a miRNA in a sample. In certain embodiments, each probe of the MMChip selectively binds a biologically active mature miRNA in a sample.

Exemplary MMChips made in accordance with the present invention can include: probes for at least about 1 to about 20 miRNAs; probes for at least about 200 to about 100 miRNAs; probes for at least about 100 to about 150 miRNAs; probes for at least about 150 to about 250 miRNAs; probes for at least about 250 to about 350 miRNAs; probes for at least about 260 to about 350 miRNAs; probes for at least about 350 to about 450 miRNAs; probes for at least about 450 to about 800 miRNAs; or probes for at least about 800 to about 1200 miRNAs.

An MM Chip made in accordance with the present invention can include any number or combination of probes that selectively bind miRNAs, without departing from the spirit and scope of the present invention. Examples of such probes and the miRNAs which they specifically bind are set forth in FIGS. 1-4. The probes can be selected from those set forth in FIGS. 1A and 2, or may be otherwise selected based on their ability to selectively bind miRNAs of interest, including, but not limited to, the miRNAs identified in FIGS. 1-4.

Human micro-RNA sequences (SEQ ID NOS: 1-19) and related micro-RNA identifiers (miRNA IDs), nucleotide sequences of human miRNAs substituted with DNA bases (cDNA copies) (SEQ ID NOS: 20-38), and nucleotide sequences of exemplary probes (SEQ ID NOS: 39-57) that specifically bind the human miRNAs of SEQ ID NOS: 1-19, or the human miRNAs substituted with DNA bases of SEQ ID NOS: 20-38, are set forth in FIG. 1A. Micro-RNA identifiers (miRNA ID) of human miRNAs that are listed in the Sanger Database, are set forth in FIG. 1B.

Canine micro-RNAs sequences (SEQ ID NOS: 58-160) and related miRNA IDs, nucleotide sequences of cDNA copies of canine miRNAs (SEQ ID NOS: 161-263), and nucleotide sequences of exemplary probes (SEQ ID NOS: 264-366) that specifically bind the canine miRNAs of SEQ ID NOS: 58-160, or the canine miRNAs substituted with DNA bases of SEQ ID NOS: 161-263, are set forth in FIG. 2.

Micro-RNA identifiers (miRNA ID) of mouse miRNAs that are listed in the Sanger Database are set forth in FIG. 3.

Micro-RNA identifiers (miRNA ID) of rat miRNAs that are listed in the Sanger Database are set forth in FIG. 4.

In certain embodiments, it may be desirable to provide an MM Chip containing probes for miRNAs of multiple species. In this regard, the MMChip can include probes for miRNAs selected from miRNAs having sequences according to SEQ ID NOS: 1-19, miRNAs having sequences according to SEQ ID NOS: 58-160, and miRNAs as set forth in FIGS. 1B, 2, 3, and 4. In certain embodiments, the MMChip includes probes having sequences that are complementary to miRNAs of interest, and are selected from probes having sequences comprising SEQ ID NOS: 39-57, probes having sequences comprising SEQ ID NOS: 264-366, sequences complementary to the miRNAs identified in FIGS. 1B, 3, and 4.

In certain embodiments, it may be desirable to provide an MMChip that is species-specific. In this regard, the MMChip can include probes for miRNA of a particular species. For example, exemplary MMChips include probes for human miRNA. An exemplary human MMChip made in accordance with the present invention includes probes for human miRNAs, wherein at least one probe is for a unique miRNA selected from human miRNAs having sequences according to SEQ ID NOS: 1-19. In certain embodiments, the human MMChip additionally includes probes for human miRNAs selected from miRNAs identified in FIG. 1B. In certain embodiments, the human MMChip includes probes for each of the human miRNAs according to SEQ ID NOS: 1-19 and for each of the human miRNAs identified in FIG. 1B.

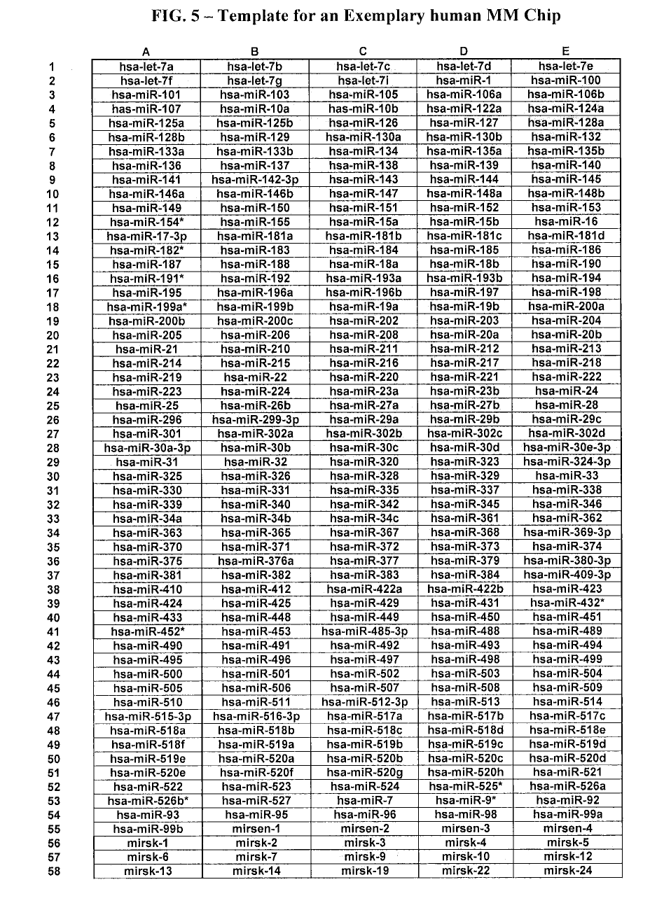

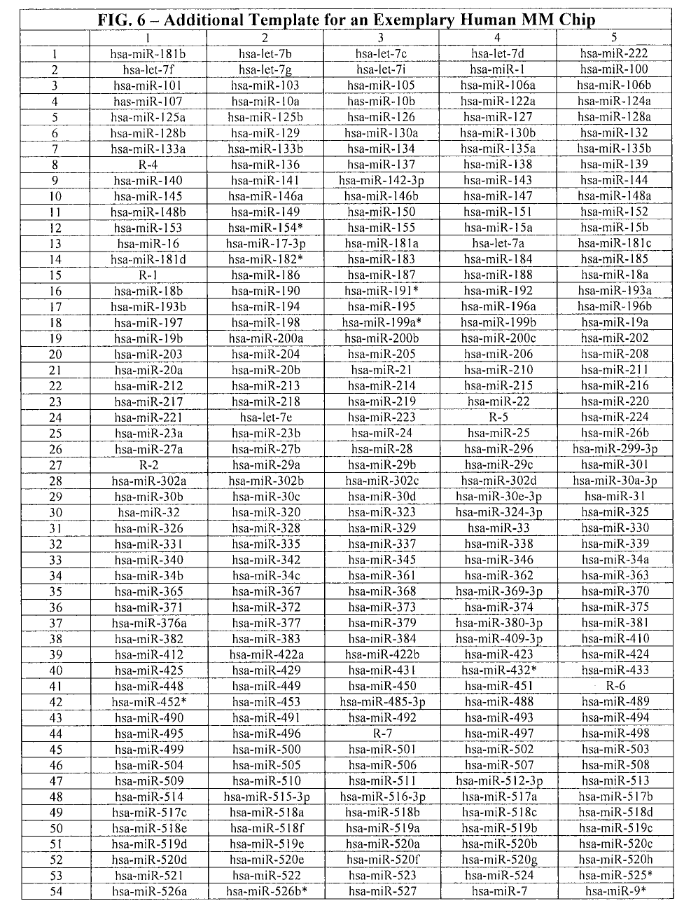

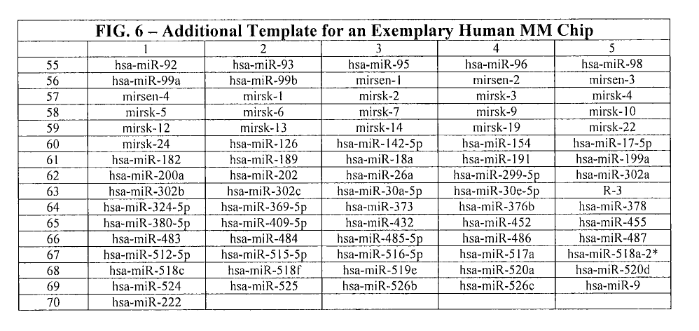

Another exemplary human MMChip made in accordance with the present invention includes probes having sequences that are complementary to human miRNAs of interest, and includes at least one probe selected from probes having sequences according to SEQ ID NOS: 39-57. In certain embodiments, the human MMChip additionally includes probes for human miRNAs selected from probes that are complementary to the miRNAs identified in FIG. 1B. In certain embodiments, the human MMChip includes the probes having sequences according to SEQ ID NOS: 39-57 and probes that are complementary to the miRNAs identified in FIG. 1B. FIGS. 5 and 6 provide templates for two exemplary human MM Chips of the present invention, wherein the relative locations of the probes are identified by miRNA ID.

Another example of a species-specific MMChip includes canine miRNA probes. An exemplary canine MMChip made in accordance with the present invention includes probes for canine miRNAs, wherein at least one probe selectively binds canine miRNAs having sequences according to SEQ ID NOS: 58-160, or from canine miRNAs substituted with DNA bases having sequences according to SEQ ID NOS: 161-263 (cDNA copies). In certain embodiments, the canine MMChip includes probes for each of the canine mRNAs having sequences according to SEQ ID NOS: 58-160. In certain embodiments, the canine MMChip includes probes for each of the canine miRNAs substituted with DNA bases having sequences according to SEQ ID NOS: 161-263 (cDNA copies). Another exemplary canine MMChip made in accordance with the present invention includes probes having sequences that are complementary to canine miRNAs of interest, and includes at least one probe selected from probes having sequences according to SEQ ID NOS: 264-366. In certain embodiments, the canine MMChip includes the probes having sequences according to SEQ ID NOS: 264-366. FIG. 7 provides a template for an exemplary canine MM Chip of the present invention wherein the relative location of the probes are identified by miRNA IDs.

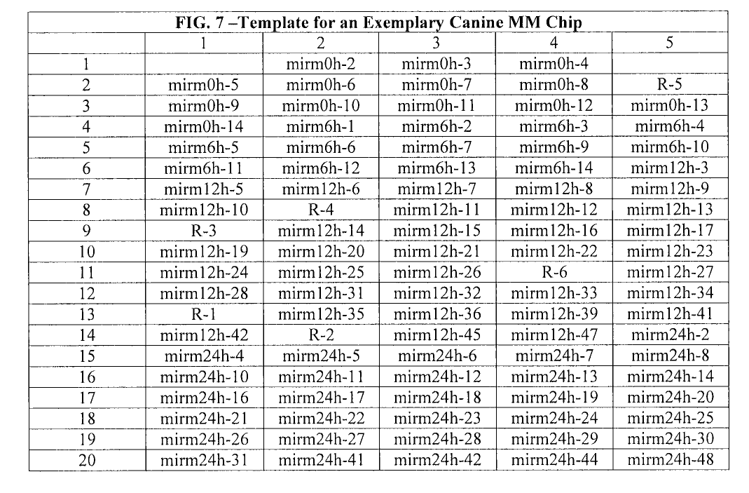

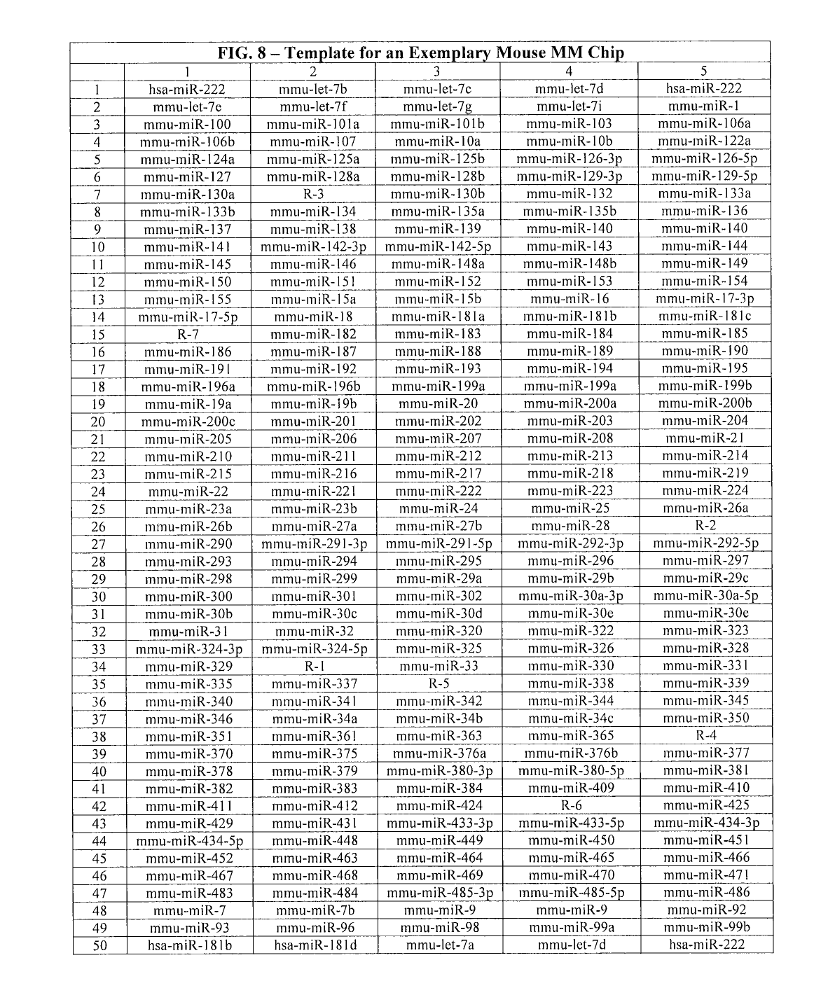

Another example of a species-specific MMChip includes mouse miRNA probes. An exemplary mouse MMChip made in accordance with the present invention includes probes for mouse miRNAs, wherein at least one probe selectively binds mouse miRNAs identified in FIG. 3. In certain embodiments, the mouse MMChip includes probes for each of the mouse miRNAs identified in FIG. 3. Another exemplary mouse MMChip made in accordance with the present invention includes probes having sequences that are complementary to mouse miRNAs of interest, and includes at least one probe that is complementary to a mouse miRNAs identified in FIG. 3. In certain embodiments, the mouse MMChip includes probes that are complementary to each mouse miRNA identified in FIG. 3. FIG. 8 provides a template for an exemplary mouse MM Chip of the present invention wherein the relative location of the probes are identified by miRNA IDs.

Another example of a species-specific MMChip includes rat miRNA probes. An exemplary rat MMChip made in accordance with the present invention includes probes for rat miRNAs, wherein at least one probe selectively binds rat miRNAs as identified in FIG. 4. In certain embodiments, the rat MMChip includes probes for each of the rat miRNAs identified in FIG. 4. Another exemplary rat MMChip made in accordance with the present invention includes probes having sequences that are complementary to rat miRNAs of interest, and includes at least one probe that is complementary to a rat miRNAs identified in FIG. 4. In certain embodiments, the rat MMChip includes probes that are complementary to each rat miRNA identified in FIG. 4.

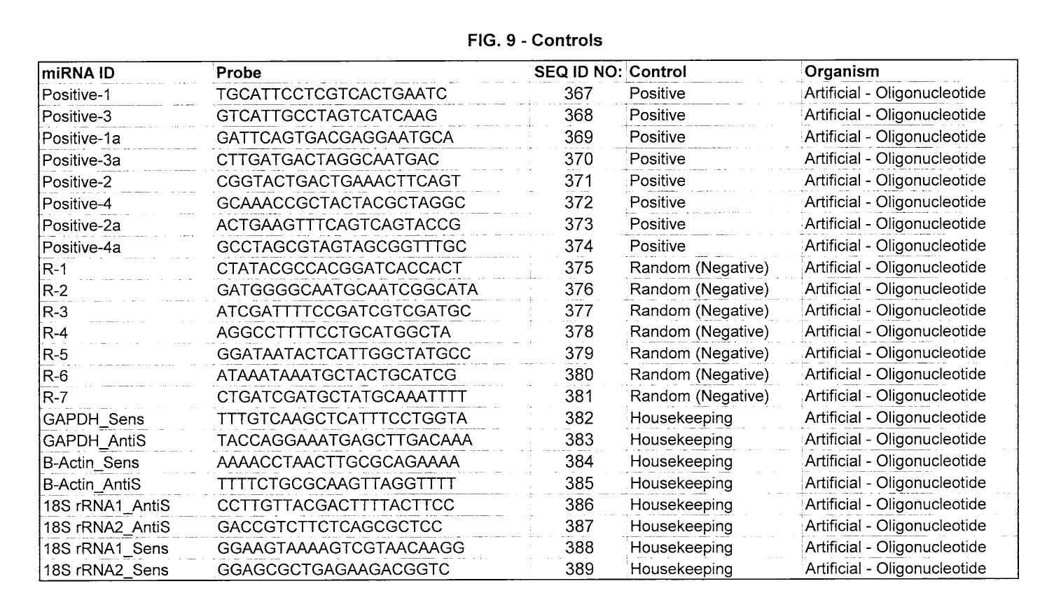

As a refinement, an MM Chip of the present invention can also include one or more positive or negative controls. For example, oligonucleotides with randomized sequences can be used as positive controls, indicating orientation of the MMChip based on where they are placed on the MMChip, and providing controls for the detection time of the MMChip when it is used for detecting miRNAs in a sample. Probes having sequences according to SEQ ID NOS: 367-374, as set forth in FIG. 9, can be used as exemplary positive controls. For another example, an oligonucleotide that is complementary to a short RNA sequence that is randomly generated can be used as a negative control, for example, probes having sequences according to SEQ ID NOS: 375-381, as set forth in FIG. 9. For another example, an oligonucleotide representing housekeeping genes, such as GAPDH, β-actin, and 18S rRNA, can be used as negative controls for total RNA degradation. Probes having sequences according to SEQ ID NOS: 382-389, as set forth in FIG. 9, can be used as exemplary negative controls for total RNA degradation. It is contemplated that any number of positive or negative controls can be included on an MM Chip made in accordance with the present invention; such controls may be selected from the exemplary control probes set forth in FIG. 9, or can be otherwise selected based on their ability to act as effective controls.

Embodiments of the MMChip can be made in the following manner. The oligonucleotide probes to be included in the MMChip are selected and obtained. The probes can be selected, for example, based on a particular subset of miRNAs of interest. The probes can be synthesized using methods and materials known to those skilled in the art, or they can be synthesized by and obtained from a commercial source, such as Alpha DNA Company (Montreal, Quebec, Canada).

Each discrete probe is then attached to an appropriate platform in a discrete location, to provide an organized array of probes. Appropriate platforms include membranes and glass slides. Appropriate membranes include nylon membranes and nitrocellulose membranes. The probes are attached to the platform using methods and materials known to those skilled in the art. Briefly, the probes can be attached to the platform by synthesizing the probes directly on the platform, or probe-spotting using a contact or non-contact printing system. Probe-spotting can be accomplished using any of several commercially available systems, such as the GeneMachines™ OmniGrid (San Carlos, Calif.). Additional information related to making an array of oligonucleotide probes can be found in U.S. patent application Ser. No. 11/553,513, filed Oct. 27, 2006, entitled “Thematic microarrays having enhanced specificity to screen genes, and related methods,” which is incorporated herein by this reference.

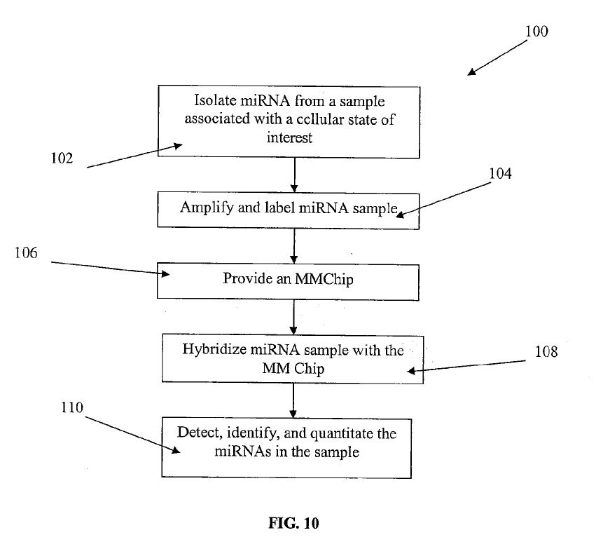

Methods and systems of the present invention will now be described. The present invention includes methods for detecting, identifying, and quantitating miRNAs in a sample. With reference to FIG. 10, an exemplary method 100 of the present invention includes the following steps: isolating miRNA from a sample 102; amplifying and labeling the miRNA sample 104; providing an MMChip made in accordance with the present invention and including probes for miRNAs of interest 106; hybridizing the miRNA sample with the MM Chip 108; and detecting, identifying, and quantitating the miRNAs in the sample 110.

Micro-RNA can be isolated from a sample 102 in the following exemplary manner. A sample of interest, for example, a tissue or cell sample is provided. The sample can be associated with a particular cellular state of interest. Total RNA is extracted from the sample using Trizol (Invitrogen Corporation, Carlsbad, Calif.), in accordance with the manufacturers instructions. Briefly, Trizol is added to the samples. Tissue samples are homogenized in the Trizol. For cultured cell samples, Trizol is added to culture dishes and the cells are scraped. The Trizol-sample mixtures are divided into aliquots, and placed in tubes. Chloroform is added to the Trizol-sample mixtures, and the tubes are incubated at room temperature before being centrifuged. Three phases appear after centrifugation, and the upper-most aqueous phase is transferred to a new tube. Isopropyl alcohol and Trizol are added to precipitate the RNA. The sample is centrifuged to create a total RNA pellet. For an exemplary method, the desired sample size for total RNA is about 1.2 mg to about 2 mg. The total RNA sample is diluted in RNase-free water. Sodium Chloride (5M) and PEG 8000 are added, and the sample is mixed and incubated at about 4° C. NaC₂H₃O₂ (3M) and ethanol (95%) are added. The sample is centrifuged and incubated at −20° C. The sample is treated to a series of centrifugations and washes to isolate the microRNA. The concentration of the miRNA sample can be measured using a spectrophotometer. Additional information about miRNA isolation can be found in the Examples portion of this document, and in Thomson, et al. Nat. Meth 1, 47-53 (2004), which is incorporated herein by this reference.

The miRNA sample is amplified and labeled 104 as is appropriate or desired. If amplification is desired, methods known to those skilled in the art can be applied. The miRNA samples can be labeled using various methods known to those skilled in the art. In certain embodiments, the miRNA samples are labeled with digoxigenin using a Digoxigenin (DIG) Nucleotide Tailing Kit (Roche Diagnostics Corporation, Indianapolis, Ind.) in a GeneAmp® PCR System 9700 (Applied Biosystems, Foster City, Calif.). Additional information about DIG labeling can be found in the Examples portion of this document, and in Semov, et al. Analytical Biochemistry 302, 38-51 (2002).

An MMChip is provided 106, which is made in accordance with the present invention, as described above. The MMChip includes probes for miRNAs. The MMChip that is provided can particular probes a sub-set of miRNAs of interest, as desired.

The labeled miRNA sample is incubated with the MM Chip 108, allowing the miRNAs in the sample to hybridize with a probe specific for the miRNAs in the sample. In certain embodiments, the labeled miRNA sample is added to a DIG Easy Hyb Solution or Hybrid Easy Buffer (Roche Diagnostics Corporation, Indianapolis, Ind.) that has been preheated to hybridization temperature. The miRNA sample is the incubated with the MMChip in the solution, for example, for about 4 hours to about 24 hours.

The miRNAsin the sample can be detected, identified, and quantitated 110 in the following manner. After the miRNA sample has been incubated with the MMChip for an appropriate time period, the MMChip is washed with a series of washing buffers, and then incubated with a blocking buffer. When Digoxigenin (DIG) labeling of the miRNA samples has been used, the MMChip is then incubated with an Anti-DIG-AP antibody (Roche Diagnostics Corporation, Indianapolis, Ind.). The MMChip is them washed with washing buffer and incubated with detection buffer, for example, for about 5 minutes. NBT/BCIP dye (5-Bromo-4-Chloro-3′-Indolyphosphate p-Toluidine Salt and NBT Nitro-Blue Tetrazolium Chloride) diluted with detection buffer is added to the MMChip, which is allowed to develop in the dark, for example, for about 1 hour to about 2 days under humid conditions.

The MMChips are scanned, for example, using an Epson Expression 1680 Scanner (Seiko Epson Corporation, Long Beach, Calif.) at a resolution of about 1500 dpi and 16-bit grayscale. The MMChip images are analyzed using Array-Pro Analyzer (Media Cybernetics, Inc., Silver Spring, Md.) software. Because the identity of the miRNA probes on the MMChip are known, the sample can be identified as including particular miRNAs when spots of hybridized miRNAs-and-probes are visualized. Additionally, the density of the spots can be obtained and used to quantitate the identified miRNAs in the sample.

The identity and relative quantity of miRNAs in a sample can be used to provide an miRNA profiles for a particular sample. An miRNA profile for a sample includes information about the identities of miRNAs contained in the sample, quantitative levels of miRNAs contained in the sample, and/or changes in quantitative levels of miRNAs relative to another sample. For example, an miRNA profile for a sample includes information about the identities, quantitative levels, and/or changes in quantitative levels of miRNAs associated a particular cellular type, process, condition of interest, or other cellular state. Such information can be used, for diagnostic purposes, drug development, drug screening and/or drug efficacy testing. For example, with regard to diagnostics, if it is known that the presence or absence of a particular miRNA or group of miRNAs is associated with the presence or absence of a particular condition of interest, then a diagnosis of the condition can be made by obtaining the miRNA profile of a sample taken from a patient being diagnosed.

Turning now to FIG. 11, another exemplary method 200 of the present invention includes the following steps: isolating miRNA from a first sample associated with a first cellular state of interest 202; isolating miRNA from a second sample associated with a second cellular state of interest 204; amplifying and labeling the first isolated miRNA sample 206; amplifying and labeling the second isolated miRNA sample 208; providing a first MMChip made in accordance with the present invention and including probes for miRNAs of interest 210; providing a second MMChip made in accordance with the present invention and having a template that is the same as that of the first MMChip 212; hybridizing the first miRNA sample with a first MM Chip 214; hybridizing the second miRNA sample with a second MM Chip 216; detecting, identifying and quantitating the miRNAs in the first miRNA sample 218; detecting, identifying and quantitating the miRNAs in the second miRNA sample 220; and comparing the information obtained for the first miRNA sample with the information obtained for the second miRNA sample to obtain an miRNA profile for the change in cellular state 222. The miRNA profile for the change in cellular state includes the quantitated up- and down-regulations of identified miRNAs, which are associated with the change in cellular state. The steps of the method set forth in FIG. 11 can be conducted as described above. The images of the first and second MMChips are analyzed using Array-Pro Analyzer, and the visualized spots of hybridized miRNAs-and-probes are compared to determine the relative changes miRNAs that are associated with the change in cellular state.

The first and second cellular states of the exemplary method may be chosen among any that are of interest. For example, if one is interested in identifying the change in mRNA profile associated with a particular condition, such as influenza infection, the first sample could be taken from uninfected cells, while the second sample could be taken from cells infected with influenza. For another example, if the condition of interest is replicative senescence, the first sample could be taken from young dividing cells, while the second sample could be taken from cells that are known to be replicatively senescent. If one is interested in studying the efficacy of a test drug, for example, the first sample could be taken from cells infected with a condition of interest, while the second sample could be taken from cells infected with the condition of interest, which have also been treated with the test drug.

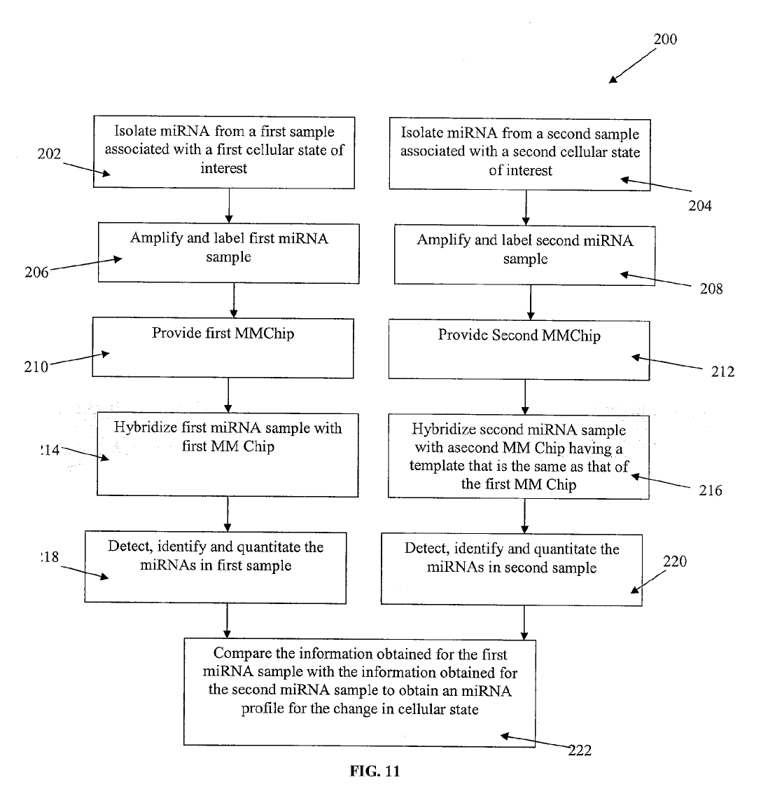

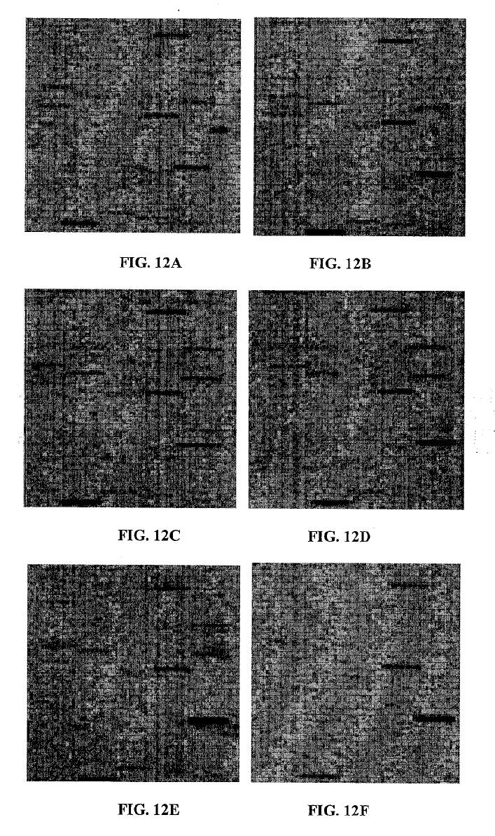

Of course, more than two samples and cellular states may be compared using the method of the present invention; for example, a time course of changes in miRNA profiles associated with a condition of interest can be conducted using multiple samples, including an untreated control sample and treated test samples, each test sample being exposed to the condition of interest for a different time period. FIG. 12A-12F are images of exemplary human MMChips that are part of a time course study, where miRNA samples are isolated from human cells infected with influenza for 0, 6, 12, 24, 48, and 72 hours. Similarly, for another example, a dose response study could be conducted by including an untreated control sample and multiple test samples, each test sample being exposed to a different dose of a treatment agent of interest.

By the methods disclosed herein, miRNA profiles may be obtained and/or compared to other miRNA profiles for any cellular state of interest, and for any number of cellular states of interest, without departing from the spirit and scope of the present invention.

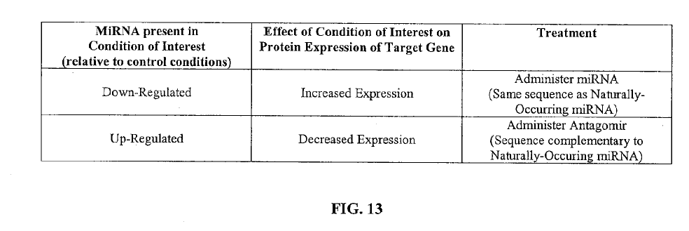

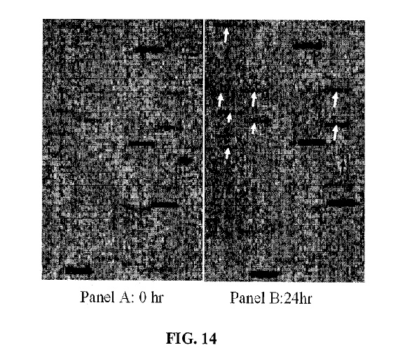

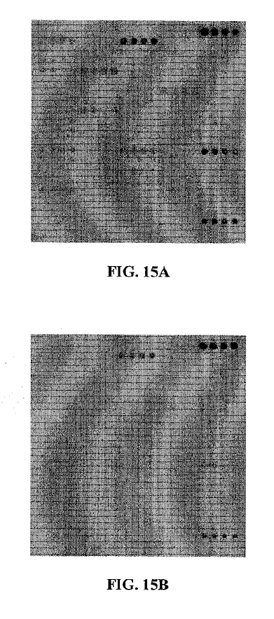

MicroRNA profiles can be used for a variety of useful purposes. For example, as mentioned above, they can be used to diagnose the presence or absence of a condition of interest. Also as mentioned above, miRNA profiles can be compared to identify and/or quantitate up- and/or down-regulations of miRNAs. Particular up- and down-regulated miRNAs of interest can be referred to as “signature miRNAs.” In this regard, the methods of the present invention can be used to identify signature miRNAs associated with a condition of interest, and gene-based drugs that can be administered to treat the condition of interest. Gene-based drugs can include exogenous miRNAs or Antagomirs (complementary to naturally-occurring miRNAs). With reference to FIG. 13, if a particular signature miRNA is down-regulated in association with a condition of interest, an exogenous miRNA having the same sequence as the naturally-occurring down-regulated miRNA can be prepared and used to treat the condition of interest. It is contemplated that an exogenous miRNA-based drug could be administered to a cell culture, an experimental animal, or a patient suffering from the condition of interest to compensate for the decreased levels of the signature miRNA. Like the naturally occurring miRNA, the synthesized miRNA bearing the same sequence will bind and repress the expression of the target gene(s). Similarly, if a particular signature miRNA is up-regulated in association with a condition of interest, an antagomir, having a sequence complementary to the naturally-occurring miRNA, can be prepared and administered to treat the condition of interest. The antagomir will bind the naturally-occurring up-regulated miRNA, keeping it from binding the target gene, thereby compensating for the increased levels of the signature miRNA. Information related to designing gene-based drug is described in U.S. patent application Ser. No. 11/246,491, entitled “Selective Killing of Replicatively Senescent Cells,” and U.S. patent application Ser. No. 11/283,081, entitled “Gene-based Drugs and Method for Designing and Identifying Same,” both of which are incorporated herein by this reference.

Systems of the present invention can include an MMChip made in accordance with the present invention, and one or more reagents useful for detecting, identifying, and quantitating miRNAs in a sample. For example, an exemplary system of the present invention includes an MMChip, a Digoxingenin (DIG) Nucleotide Tailing Kit (Roche Diagnostics Corporation, Indianapolis, Ind.) for labeling miRNA samples, and anti-DIG-AP antibody (Roche Diagnostics Corporation, Indianapolis, Ind.) and NBT/BCIP dye for detecting the miRNA-probe hybridization spots.

The present invention additionally includes novel isolated nucleic acid molecules, i.e. discovered by the Inventor and not previously reported in the literature. The human miRNAs according to SEQ ID NOS: 1-19 were discovered by the Inventor of the present invention. The present invention includes isolated nucleotide molecules according to SEQ ID NOS: 1-19, which are useful as exogenous miRNAs for treating conditions associated with down-regulation of naturally occurring miRNAs of the same sequence. The present invention includes isolated nucleotide molecules that are complementary to SEQ ID NOS: 1-19, which are useful as antagomirs for treating conditions associated with up-regulation of naturally occurring miRNAs according to SEQ ID NOS: 1-19. The present invention includes isolated nucleotide molecules according to SEQ ID NOS: 39-57, which are useful as probes for miRNAs according to SEQ ID NOS: 1-19.

The canine miRNAs according to SEQ ID NOS: 58-160 were discovered by the Inventor of the present invention. The present invention includes isolated nucleotide molecules according to SEQ ID NOS: 58-160, which are useful as exogenous miRNAs for treating conditions associated with down-regulation of naturally occurring miRNAs of the same sequence. The present invention includes isolated nucleotide molecules that are complementary to SEQ ID NOS: 58-160, which are useful as antagomirs for treating conditions associated with up-regulation of naturally occurring miRNAs according to SEQ ID NOS: 58-160. The present invention includes isolated nucleotide molecules according to SEQ ID NOS: 264-366, which are useful as probes for miRNAs according to SEQ ID NOS: 58-160.

The present invention is further illustrated by the following specific but non-limiting examples. The following examples include prophetic examples and other examples that may include compilations of data that are representative of data gathered at various times during the course of development and experimentation related to the present invention.

### EXAMPLES

Species-specific MM Chips, including human, mouse, rat, and canine-specific MM Chips, are constructed. The miRNAs used to design these MM Chips are obtained by: (1) identifying all known microRNAs that have been reported via public databases; (2) proteomic data and text mining known miRNAs targeted to the up- or down-regulated proteins; and (3) isolating, cloning and sequencing novel microRNAs. The miRNAs from these sources are combined and used to generate species-specific MM Chips. Exemplary human MM Chips can include probes for about 478 different human miRNAs, as set forth in FIG. 1A and FIG. 1B. An exemplary canine MM Chip can include probes for about 103 miRNAs, as set forth in FIG. 2. An exemplary mouse MM Chip may include probes for about 361 miRNAs, as set forth in FIG. 3. An exemplary rat MM Chip may include probes for about 238 miRNAs, as set forth in FIG. 4.

An exemplary method for obtaining miRNA from a cell sample makes use of the following materials: Trizol solution (Gibco); Chloroform; Isopropyl alcohol; 70% ethanol; RNase-free water; PEG 8000; 5M NaCl; 95% ethanol; and 3M NaC₂H₃O₂. Experimentally treated cells are provided and washed 2 or 3 times with 3 ml phosphate-buffered saline (PBS). Another 1.5 ml PBS is added to the plate; the cells are scraped and transferred into a 1.5 ml micro-tube. The tubes are centrifuged for 1 minute at 6000 rpm, the clear liquid is removed, and the cell pellets are used for RNA isolation, or frozen and kept at −80° C. until ready to be used. Trizol reagent (Invitrogen Corporation, Carlsbad, Calif.) is used to isolate total RNAs according to the manufacturer's recommendations. One milliliter of Trizol reagent is added to each tube containing a cell pellet. The RNA is precipitated by adding 0.2 ml chloroform to each tube, centrifuging the sample, and removing the supernatant.

Fifteen to twenty micrograms of total RNA is loaded onto a 0.7% agarose gel; the low molecular weight (5.8 S and below) RNA portion is cut and fit into 3 ml syringes with glass wool at the bottom. The gel is mechanically squeezed to collect the liquid into 1.5 ml tubes; this sample is precipitated with 0.1×3M sodium acetate and 2× ethanol for 1 h at −80° C. RNA is precipitated by centrifugation at maximum speed for 10-15 minutes, and reconstituted in 30 μl Tris buffer. Half of the precipitated small RNA is loaded onto a 12% polyacrylamide gel run at 150V for 2-4 hours. Sections of 15-25 nt are cut and collected into 1.5 ml tubes. The miRNA in the tubes is eluted overnight with 0.3M NaCl in TE Tris buffer at 4° C., centrifuged and reconstituted in 10 μl 0.25×Tris buffer.

Three microliters of the isolated miRNA is used for 3′ adapter ligation. The 3′ adapter (made by IDT, Integrated DNA Technologies) is 5rApp/CTGTAGGCACCATCAAT/3ddC, with an adenylated RNA base at the 5′ end and a dideoxy C base at the 3′ end, to block mis-ligation to the 5′ end of miRNAs. Ligation is carried out at 16° C. overnight with T4 RNA ligase (Promega). The ligated product is separated on a 12% polyacrylamide gel; bands at about 34-44 nt are isolated and eluted as described above. The eluted, 3′ ligated miRNA is rephosphorylated with T4 RNA kinase (Promega or New England Biolabs), precipitated, and used for 5′ ligation. The 5′ adapter (5′ATCGTrArGrGrCrArCrCrUrGrArArA3′, IDT, r denotes RNA base) is ligated as for 3′ ligation. Ligated products with size increases of both adapters are isolated and eluted.

RT-PCR is carried out on these ligated miRNAs with primers of the same sequences as the adapters, but all standard DNA bases (use 3 μl of ligated miRNA in 50 μl volume RT followed by 50 μl volume PCR). PCR products are precipitated and digested with BanI (Promega, site engineered into the adapters) and phenol/chloroform extracted, precipitated and concatemerized with Fast Link ligase (Epicentre) for 3 hours or with T4 DNA ligase overnight. The concatemerized products are blunt-ended with an end repair kit (Epicentre), and adenylated with Taq DNA polymerase (Promega; added to 50 μl reaction volume) for 30 min at 72° C. This product is cloned into pGEM-T easy TA cloning vector (Promega). The DNA is ligated to pGEM-T Easy vector with T4 DNA. The cloned product is transformed to JM 109 or DH5α, plated to an ampicillin/X-Gal LB plate, and incubated overnight at 37° C. White colonies are selected and grown in ampicillin LB medium overnight at 37° C. The plasmid clones are isolated with Qiagen's plasmid mini column prep kit, digested with EcoRI, run on an agarose gel and large-insert plasmids are picked for sequencing. The plasmid clones are sequenced at a sequencing facility at the University of Louisville.

### Example 1

### Constructing Exemplary MMChips

Exemplary miRNA microarray platforms are generated, including: human, canine, mouse, and rat MMChips, each containing microRNA probes, and further including a total microRNA fraction as a positive control, and oligonucleotides of computer-generated randomized sequences as negative controls. Individual human, canine, mouse, and rat miRNAs from the database, either from the public domain or those unique to the present invention, are processed to synthesize oligonucleotides bearing complementary antisense DNA sequences, for use as miRNA probes. FIGS. 1-4 include sequences for miRNAs and associated probes, and also include miRNAs identified by miRNA IDs.

Individual antisense DNA oligonucleotides of miRNA are used to make MMChips. Commercially available robotic systems can be used to produce accurate, medium density MMChips. Robotic systems are accurate in depositing miRNA-oligonucleotides onto the chips; one micron distances are maintained between loci of four printed oligonucleotides. These features allow for rapid and cost-effective production of high quality MMChips. These exemplary MMChips are manufactured to maximize the power of final statistical analysis, and minimize signal-to-noise ratio, as well as false positive or negative results. Two equally successful protocols, with target specimens labeled by either P32 or digoxigenin end-labeling, are developed and described below.

### Example 2

### Isolating MicroRNAs from Sample for Hybridizing with MMChip

The following exemplary method is used to obtain an miRNA sample for hybridizing with an MM Chip. The method generally includes the steps of: isolating total RNA from cells; separating miRNA from total RNA; carrying out adapter ligation; and amplifying and cloning the sample. Portions of this method are adapted from Lau et al. (2001), which is a modification of Elbashir et al. (2001).

Total RNA Extraction. To extract total RNA from intact tissues, the following exemplary method may be used. The intact tissues are weighed on a balance and the weight is recorded. The tissues are cut into small pieces while still frozen, and placed into a 50 ml Falcon tube; 1 ml Trizol is added for each 50-100 mg of weighed tissues. Tissues are homogenized in a Polytron homogenizer (Kinematica AG, Switzerland) for 30 seconds. For tissue culture add 1 ml Trizol per tissue culture dish and scrape the cells. Aliquot homogenized tissue/Trizol mixtures into 1.5 ml tubes with 1 ml for each tube. If total RNA is extracted from cultured cells, 1 ml Trizol per tissue culture dish is added and cells are scraped. In any event, the homogenized tissue/Trizol mixtures are divided into 1 ml aliquots and placed in 1.5 ml tubes.

Chloroform is added to the tubes in a ratio of 0.2 ml chloroform/1 ml Trizol and shaken for 15 seconds. The tubes are incubated at room temperature for 3 minutes before being centrifuged at 12,000 rpm for 15 minutes at 4° C. Three phases will appear after centrifugation. The upper aqueous phase is transferred to a fresh 1.5 ml tube. 0.5 ml of isopropyl alcohol/1 ml Trizol is added to precipitate RNA. The tubes are shaken for 15 seconds and incubated for 10 minutes at room temperature.

The sample is then centrifuged for 30-60 minutes at 12,000 rpm at 4° C., which results in a pellet. The supernatant is removed by pipetting and discarded, and the RNA pellet is keep on ice. The RNA is washed with 1 ml of 70% ethanol and vortexed briefly. The sample is again centrifuged at 12,000 rpm at 4° C. for 30 minutes. The supernatant is removed and discarded by pipetting. The RNA pellet is dried in a Speed Vac for 3-5 minutes. Fifty to 100 μl of RNase-free water is added to the tube and the sample is mixed well. The sample is incubated at 60° C. in a water bath for 10 minutes. The RNA is mixed well with the RNase-free water by pipetting, spun down, and kept on ice. The RNA concentration for each sample is measured using a spectrophotometer. For this exemplary miRNA extraction procedure, the desired sample size is 1.2-2 mg of total RNA.

Extraction of miRNA from Total RNA. For 1.2-2 mg total RNA, RNase-free water is used to bring the sample to 400 μl. Fifty microliters of 5M NaCl and 50 μl PEG 8000 are then added, the sample is mixed well, and incubated on ice for 2 hours. The sample is then centrifuged for 10 minutes at 13,000 rpm at 4° C. Fifty microliters of 3M NaC₂H₃O₂ and 1 ml 95% ethanol is added to the 500 μl sample mixture. The sample is spun down and incubated at −20° C. for 2 hours. The sample is then centrifuged for 10 minutes at 13,000 rpm at 4° C., the supernatant is removed, and the pellet is washed with 1 ml 75% ethanol. The sample is again centrifuged for 10 minutes at 13,000 rpm at 4° C. and the supernatant is removed. The RNA pellet is dried in a Speed Vac for 3-5 minutes. Fifty to 100 μl of RNase-free water is added to the tube containing the RNA pellet and the sample is mixed well, and incubated at 60° C. in a water bath for 10 minutes. The miRNA pellet is further mixed well with water by pipetting, spun down, and kept on ice. The miRNA concentration for each sample is measured using a spectrophotometer. The miRNA sample is stored at −80° C.

### Example 3

### Hybridization of Sample MiRNAs with MMChip

The following exemplary method is used to hybridize the miRNA sample to an MM Chip. The following materials are provided: Roche kit #1417231; DIG Easy Hyb; 10× Maleic Acid (1M Maleic Acid (pH 7.5), 1.5M NaCl); 10× Detection Buffer (1M Tris (pH 9.5), 1.5M NaCl); 1× Stopping Buffer (20 mM Tris-HCl (pH 2.9), 1 mM EDTA); 1× Washing Buffer (0.1 M Maleic Acid/50 ml of 1M Maleic Acid, 0.15 M NaCl/75 ml of 1M NaCl, 0.3% Tween 20/1.5 ml of Tween 20); 10% Blocking Buffer (Add 10 g Blocking reagent Powder in 100 ml of 1× Maleic Acid Buffer. Heat and melt solution. Autoclave solution and aliquot the solution into 15 ml Falcon tubes); 20×SSC Buffer (Add 88.2 grams of sodium citrate and 175.3 grams of sodium chloride. Adjust pH to 7.0 and adjust volume to 1 litre, then autoclave); and 10% SDS Solution (Add 50 g sodium dodecyl sulfate and distilled water into bottle, adjust volume to 500 ml and autoclave).

### Example 3a

### DIG Labeling Method

Prehybridization: Two milliliters of DIG Easy Hyb solution is pre-warmed in a 5 ml Falcon tube at a hybridization temperature for at least 20 minutes. Single stranded DNA (ssDNA) is denatured (10 mg/ul) at 95-100° C. for 10 minutes and quenched on ice. Twenty microliters of ssDNA is added into prewarmed Easy Hyb solution. A dry MM Chip membrane is placed directly into the solution and incubated for at least 1-2 hours.

Labeling (oligonucleotide tailing): A tailing matrix is prepared containing the following: miRNA (5-10 μg); Reaction Buffer (#1) (4 μl); CoCl2 (#2) (4 μl); DIG-dUTP (#3) (1 μl); dATP (#4) (1 μl); 50 U Terminal Transferase (#5) (1 μl); Water up to 20 μl. The ingredients are mixed well and centrifuged briefly before being incubated at 37° C. for 15 minutes and placed on ice. Two microliters of 0.2 M EDTA is added to stop the reaction.

Hybridization: One milliliter of DIG Easy Hyb is preheated at hybridization temperature. The tailed miRNA matrix is added to the preheated solution and incubated membrane in mixture for 4 hr overnight.

Post-Hybridization Washing: The membrane is washed twice for 5 minutes in 2×SSC: SDS 0.1% (Solution 1) and then is washed twice for 5 minutes in 0.5×SSC; SDS 0.1% (Solution 2) at hybridization temperature. The membrane is finally washed in 1× Maleic Acid Buffer for 2-5 minutes.

Blocking: The membrane is incubated in 1.5-2% Blocking solution for 30 minutes.

Antibody Binding The membrane is incubated for 30 minutes in antibody (Anti-Digoxigenin-AP Fab Fragments) solution, using 1:1500 dilutions in 1.5-2% Blocking solution.

Washing: The membrane is washed twice for 15 minutes in 1× Washing buffer.

Detection: The membrane is washed in detection buffer for 2-5 minutes. NBT/BCIP dye is diluted with 1× Detection buffer at 1:50. Three-hundred microliters of diluted dye is added to each membrane and allowed to develop in the dark for 1 hr overnight. Stopping buffer is used to stop detection.

### Example 3b

### Gamma p33-Labeling Method

This procedure should be performed behind protective shields, checking often with Geiger counter to ensure safe levels of radiation around workspace, i.e., floor, shoes, counters, gloves, etc.

Prehybridization: MM Chips are incubated at 37° C. in 1 ml prewarmed MicroHyb solution for at least 30 minutes.

Labeling of Probe: The labeling matrix is prepared containing the following: miRNA (5 μl); 1× Buffer Enzyme (5 μl*); T4 Kinase Enzyme (2.5 μl); Gamma p33-ATP (3 μl); Water up to 50 μl. (*Final concentration of the Buffer Enzyme should be 1×. Before using, add 4.5 μl Dilution Buffer to 0.5 μl 10× Buffer Enzyme and add to probe matrix). Matrix is mixed thoroughly and spun down briefly before being incubated at 37° C. for 30 minutes, followed by 5 minutes at 65° C. The matrix is quenched on ice or stored at 4° C.

Hybridization: Probe matrix is added to 1 ml prewarmed MicroHyb solution. The MM Chips are inserted into probe/MicroHyb mixture and hybridized at 37° C. overnight.

Washing: The MM chips are washed twice for 10 minutes in 2×SSC: 0.5% SDS (Buffer 1) at 37° C., then washed twice for 5 minutes in 1×SSC: 0.5% SDS (Buffer 2) at 37° C.

Detection: Using a sheet of plastic wrap, the MM Chips are placed face down and the plastic wrap is folded over the back side of the MM Chips. The plastic wrap is flattened to drive out air bubbles. Using a black detection cassette, the MM Chips are placed in plastic wrap on the cassette (face down), with the orientation of the chips with the grid on the cassette documented such that the detected miRNAs can be identified based on the templates of the MM Chip and the specific samples hybridized with the various MM Chips. A cover is placed on the cassette and the cassette is placed in the dark for 24-48 hours.

Image Acquisition: The MM Chips are scanned to acquire the resulting image.

### Example 4

### Data Mining of MMChip Results

The MM Chip results are used to: (a) extract the most significant MMChip screening input data to select miRNAs validated to have potent suppressing effects on survival gene expression, with the best quality control for data collection, statistical analysis and validation; and (b) link with MMChip data collected by miRNA cloning, sequencing and proteomic studies, as well as information gathered from the public domain, allowing data mining for miRNAs and their target gene groups with the most significant effects.

Developing database and data mining bioinformatics for MMChips. For hardware set-up, a prototype Oracle server-based hardware system is established to support the proposed proteomic data management plan. A popular database management system (DBMS) is used for information generated from many different sources, including miRNA identities and their sequence information obtained from Applicant's cloning and sequencing effort, as well as MMChip profiling and validation data. It is contemplated that the massive MMChip screening data may be handled with instant access, and orchestrated into an operational system, providing a warehousing function in parallel to user/server activities.

Briefly, the following three-phase working plan is contemplated: the first phase is developing a prototype system; the second phase is implementing the entire database system; and the third phase is setting up data storage and backup system design. An e-MicroRNA Database is contemplated that is capable of supporting: (a) instant transfer of data between workstations and servers; (b) seamless work flow from data acquisition to data mining; (c) comfort of working in a safe and secure environment with confidential data; and (d) providing users data management, storage and handling of volumes of proteomic information. The developed e-MicroRNA Data base may be internet-accessible, or otherwise provided.

Experimental design for statistical analysis and data mining tasks for MMChip screening of infection-dependent profiles take the following into account: the number of culture repeats; and the number of MMChip screening repeats. ANOVA and Student's t test are used to evaluate means, standard deviations (SD), and standard error values. From these values, coefficients of variance can be generated, as well as significance threshold levels, etc. To calculate changes in miRNA abundance, i.e. specimens collected at different post-infection time points vs. mock infected, etc., significance tests are performed.

Identifying the hierarchical functional order of up-regulated signature miRNAs, and mapping their target genes and pathways for their silencing actions. From the above statistical analysis of MMChip data, coefficients of variance can be generated, as well as Bonferroni significance threshold levels, such as p<0.05, etc. For any ratio calculation of miRNA expression changes, i.e. infected/uninfected ratio, significance tests for the change may be provided. The Significance Analysis Microarray (SAM) program and the commercially available computer program, GeneSpring, sold by Silicon Genetics, Inc., of San Carlos, Calif., may be used. Other analytical methods, such as principal component analysis, hierarchical clustering, or self-organizing maps, may also be employed to select lead signature miRNAs with the most significant changes. Genes are identified as silenced targets for each signature miRNA for each infection state, and commercial programs (Strategene and Ingenuity) are used to classify them according to functional families or networks, i.e., “network footprint.” In addition, the target genes' partners or upstream or downstream regulators and their pathways may be identified with these two software programs.

### Example 5

### Use of MMChips for Screening Flu-Infection-Specific MiRNAs

MMChips are used for a study to screen miRNA profiles of A549 cells at 0, 6, 12, 24, 48, and 72 hours post-infection. Two different methods are employed, using ³²P or digoxigenin (DIG), to label isolated miRNAs. These labeled microRNAs are then hybridized to MMChips; positive reactions are visualized by radioactive or DIG-label images generated by the immobilized labeled miRNAs hybridized to specific loci. Positive reactions are readily identified as round, dark deposits at each positive locus, containing quadruple printed oligonucleotides (for increased statistical analysis power). FIG. 9 shows an image of an exemplary MMChip with miRNAs isolated from 0 and 24 hours; white arrows point to up-regulated miRNAs post-infection, black arrows to those with decreased intensity.

Data mining of triple MMChip repeats of each of six time points is pursued through the following four steps: (1) image acquisition and microarray configuration; (2) data acquisition and visualization; (3) re-scaling, thresholding and normalization; and (4) signature detection and cluster analysis. The process involved in step 1 is pre-defined by the array system's design and image acquisition device, as described above with regard to MMChip fabrication. Step 2 involves data quantification by analysis of signal intensity for each locus of the array, using various algorithms such as Image2Data, MaConvert, etc. Custom software has been developed by Applicant to perform this task by recording the intensity level for each locus on the array. However, in this step, the signal-to-noise ratio and other analysis for positive and negative controls (10 microRNAs of randomized sequence) should be considered before the actual data mining commences. The first aspect of Step 3 involves re-scaling intensity values so that overall intensity for each MMChip in the entire testing group is standardized. Afterwards, thresholding is performed to yield a constant value for a given miRNA with a quantified level below a constant, to rule out levels that do not satisfy the confidence limits of statistical analysis. The last aspect of step 3, before final data mining, is to normalize all data, in order to allow comparing miRNA loci with different absolute intensities but the same pattern or shape across a set of arrays used in each experiment. The final step 4 is the data mining task, extracting the most significant features from input data that can provide identification of unique miRNAs.

After data mining to identify signature miRNAs, a scan is conducted of the proprietary database and/or various websites in the public domain for their target genes, e.g., BLAST. Preliminary results show that: (1) most miRNA profile changes occur at 6, 12, or 24 hours post-infection, preceding the first detection of actual cell apoptotic phenotype (occurring at 48 to 72 hours), suggesting that miRNA changes prestage apoptosis signaling; (2) more miRNA species increase in intensity than decrease; and (3) 17 species with signature changes are analyzed further to identify their target genes. Most of these 17 miRNAs target genes of three pathways: MAPkinase, PI3K/AKT-survival, or BCL2/Caspase families.

Among those with increased expression, human miR-27b is increased 6-fold; since it targets both MAPK1 and AKT1, this suggests a two-pronged silencing effect on both MAPKinase, for oxidative defense, and AKT survival ability. Two other miRNAs, miR-15b and miR-33, also show two-fold up-regulation, and exhibit the same two-pronged functions as miR-27b. Besides these three miRNAs, one additional AKT-miRNA, miR-181a, also shows a 2-fold increase. This preliminary data mining analysis shows that targeting the MAPKinase/oxidative defense and PI3Kinase/AKT-survival pathways is an expedient way for flu virus to threaten cells. Although there are increases in miRNAs targeting genes of the apoptosis pathway, the total sum of this increase is less than those targeting pro-survival signaling. These preliminary results indicate to Applicant that up-regulated miRNAs targeted to silence the pro-survival program tilt the ‘Ying-Yang’ balance of survival and death towards host cell suicide. It is contemplated that the self-organizing feature map (SOFM) method may be used for in-depth data mining.

### Example 6

### Validation of Signature MiRNAs Obtained by MM Chip Screening

Northern Blotting. Cells cultured in 100 mm plates are washed twice with PBS, scraped in fresh PBS, collected into 1.5 ml microcentrifuge tubes, and pelleted. Total RNA is isolated from the pelleted cells with Trizol reagent (Invitrogen Corporation, Carlsbad, Calif.). Total RNA is separated on 15% polyacrylamide gels (20 μg/lane) and transferred to nylon membranes. Antisense DNA oligonucleotides corresponding to miRNAs to be analyzed are 5′-end labeled with γ-32P-ATP (Amersham) by T4 polynucleotide kinase (New England Biolabs). Hybridization is carried out at 42° C. overnight, followed by washing at the same temperature. Positive miRNAs should yield 2 bands, one the precursor of 60-70 nt, and the other the mature miRNA of 21 nt. Northern analysis is both qualitative and quantitative.

Real-Time PCR: A kit is available (ABI) to analyze miRNA expression quantitatively. Specific known miRNA primers are employed in this kit to reverse transcribe mature miRNAs; and, at the same time, a universal primer is added to the cDNAs, followed by real-time PCR with the universal primer and TaqMan probe. See Chen et al., 2005. Quantitative PCR can also be carried out with 3′ adapter-ligated miRNAs followed by RT-PCR with the adapter/primer and an miRNA-specific primer. See Lim et al., 2003. In cases where precursor sequences are known, primers can be designed to these sequences and real-time PCR can then be performed. See Jiang et al., 2005. Nano-range RNA amounts are needed for real-time PCR; in the case of precursor PCR, genomic DNAs can be used instead of RNA. Therefore, real-time PCR confers the advantage of saving RNA resources, especially when this resource is limited.

### Example 7

### Obtaining MiRNA Profiles for Human Fibroblasts and Human Lymphocytes Using MMChips

Cells. Human fibroblasts (WI 38) and human lymphocytes are obtained. Control and Test (special status) cells of each type are provided. In one study, the control cells are young replicative fibroblasts (about 34 population doublings, negative beta gal staining), and the Test cells are senescent fibroblasts (about 52 population doublings, >80% beta gal staining). In another study, the control cells are non-gravity treated lymphocytes, and the test cells are gravity treated lymphocytes.

Total RNA and small RNA isolation. The four types of cells (young fibroblasts, senescent fibroblasts, non-gravity treated lymphocytes, and gravity treated lymphocytes) are subjected to extraction of total RNA and then of small RNAs containing miRNAs. Because small RNA is isolated from total RNA, degradation from total RNA will increase quantity estimation for small RNA. In order to obtain small RNAs with good quality and accurate quantity RNase inhibitor is used to prevent total RNA from degradation during small RNA extraction. Total RNA of different types of human fibroblast cells, as well as young and old mouse livers, are extracted with Trizol (Invitrogen Corporation, Carlsbad, Calif.) according to the manufacturer's instructions. Small RNA is further isolated using a method similar to the one described in Thomson, et al. Nat. Meth. (2004), which is incorporated herein by reference. Briefly, about 200 ug to about 2 mg total RNA in 400 ul RNase free water is mixed with 50 ul 5M NaCl and 50 ul of 50% PEG 8000 (Sigma, USA) in a 1.5 ml microtube The mixture was then incubated on ice for at least 2 hours. Total RNA was depleted after centrifuge for 10 minutes at 13000 rpm. Supernatant containing small RNA was precipitated by adding 2 volume of 100% ethanol and 50 ul of 3M NaAC. The mixture was incubated at −20° C. for more than 2 hours. Small RNA was isolated after 10 minutes of centrifuge and washed with 70% ethanol, and then dried and dissolved microRNA pellet as usually. Finally small was measured using a spectrophotometer (Beckman Coulter, Fullerton, Calif., USA).

microRNA labeling and hybridization. About 2 to 5 μg of small RNAs are labeled using the Digoxingennucleotide Tailing Kit (Roche Diagnostics Corporation, Indianapolis, Ind.), using reagents as described in the manufacturer's instructions, for 20 minutes at 37° C. in a Gene Amp PCR system 9700 (Applied Biosystems, CA, USA).

Each microarray experiment is performed three times using triplicates of microRNA chips for each sample (i.e., three biological replicates and three experimental replicates). Pre-hybridization of MMChips in hybridization buffer is conducted in 3 ml of Hybrid Easy buffer (Roche Diagnostics Corporation, Indianapolis, Ind.) for about 30 to 60 minutes at 37° C. Hybridization is carried out with 20 ul of labeled probe in 1 ml of pre-warmed hybrid buffer for at least 4 hours or overnight. MM Chips are washed twice in washing buffer I (2×SSC, 0.1% w/v SDS) at room temperature for 20 min, then twice in washing buffer II (0.5×SSC/0.1% w/v SDS) at 37° C. for 15 min, and finally in washing buffer III (0.3% Tween-20 in 1× Maleic acid buffer). Blots are incubated in about 1.5 to 2% blocking buffer for 30 minutes, and then in 1:1500 Anti-Digoxingenin-AP antibody for another 30 minutes. The MM Chips are washed 3 times with washing buffer, followed by equilibrating chips with detection buffer for 5 minutes. Finally detected signal using 1:500 diluted NBT/BCIP reagent Roche Diagnostics Corporation, Indianapolis, Ind.) under humid condition for 1˜2 days accordingly.

Quantitative and semi-quantitative RT-PCR. Real time PCR reagent sets from Appliedbiosystem (CA, USA) are used to validate results of MMChips. Using 10 ng total RNA, RT synthesis is first performed, real-time PCR is carried out according to the manufacturer's suggested conditions: 37° C., 30 minutes; 95° C., 10 minutes of reverse transcription; 95° C., 3 minutes; 95° C., 15 seconds; 60° C., 35 seconds. The reaction is carried out for about 40 cycles. The gene expression ΔC_{T} values of miRNAs from each sample are calculated by normalizing with internal control U2 or U3 rRNA and relative quantitation values were plotted. Endogenous control and experiment control samples are run together with tested sample miRNA, each having triplicates to get accurate result. Endogenous control U2 and U2 rRNA are purchased from Appliedbiosystem (CA, USA).

MMchips preparation. Four hundred and eighty oligonucletide probes for mature miRNAs, having lengths of about 17 to 26 nt, are synthesized by alpha DNA company (Montréal, QC, Canada). All oligonucleotide probes are diluted with RNase free water to the final concentration of 200 pmol/ul mixed in 1×SSC buffer and then are fabricated in triplicate on Amersham nylon membrane with 50% humidity by Genemachines (OmniGrid, Sanlarlos, Calif., USA) with single needle configuration. The spot diameter is 100 um and the distance between spots is 100 um. The printed membranes are finally cross linked, to fix the probes onto the membrane by Uv light with energy intensity at 50 Cju, in a GS Gene Linker UV Chamber (Bio-Rad Laboratories, Hercules, Calif., USA).

Control system in MMChips. A control system is used to prevent non-specific hybridization and total RNA degradation, as well as image orientation confusion.

Two oligonucleotides with randomized sequences, are used as positive controls, for example, those set forth in FIG. 9. In addition, they are diluted in 1:1000 and 1:10000 fold, respectively, and are printed in 3 corners. These positive controls indicate orientation of the MM Chips, and provided a control for the detection time for the MMChips.

Negative controls include 1×EB buffer, 1×SSC buffer, and seven oligonucleotides having randomized sequences, for example, those set forth in FIG. 9. Four oligonucleotides of about 20 to 22 nt in length, representing house keeping genes GAPDH, β-actin, and 18S rRNA, are used as negative controls for total RNA degradation, for example, those set forth in FIG. 9.

Except for the controls printed in the 3 corners to indicate orientation, the control oligonucleotides are randomly printed on the MM Chips.

Microarray analysis. After hybridization all chips are scanned by an Epson Expression 1680 scanner (EPSON, Long Beach, Calif.) at the resolution of 1500 dpi and 16-bit grayscales. The images are cropped and pre-aligned. Microarray quantification software, Array-Pro Analyzer (Media Cybernetics, Inc., Silver Spring, Md.), is used to extract spot values on the images. Array-Pro first rotates an image, and then performs a preliminary spot detection, according to where rows and columns are located. At the intersection point of a row line and a column line, Array-Pro puts a circle with pre-defined size. Each circle will shrink to fit the spot at the intersection point. The trimmed mean of the pixel values in each circle is calculated to get the raw spot intensity. The trimmed mean of the pixel values in a ring around each spot circle is calculated as the background, which will be subtracted from the raw intensity to get the net intensity of a spot. Net intensity values of all spots on the image are normalized by dividing them by the value of the trimmed mean of all spots. The trim thresholds of all trimmed means are set as 5%. Each miRNA has three repeat probe spots and the values are averaged to get the final net signal intensity associated with the miRNA.

Array-Pro allows all net intensity values to be exported to a Microsoft Excel spreadsheet. Significance Analysis Microarray software (SAM, Stanford University, Stanford, Calif.) is used to find the significant miRNAs for all possible treatment-control pairs. In a parameter dialog box of SAM, the response type is set as two class unpaired, unlogged data, 300 permutations, and the generate button is selected to obtain a random number seed. Default values are used for the other parameters. After the calculation finished, a SAM controller dialog box appears and the delta value is chosen to obtain a comfortable false positive rate (<20%) and fold change (>1.5). A final SAM result page will provide the significantly up-regulated and/or down-regulated miRNAs lists. The spots on the images are also visually inspected, to verify that the SAM results.

Systematic optimization of the custom-made MMChips. A series of systematic optimization experiments are carried out to evaluate and monitor MMChip performance. A test hybridization assay using miRNAs mir181b and mir222 as two test target samples to check specificity of the MMChips on which perfectly matched and mismatched oligonucleotide probes are provided, which have sequences corresponding to the two miRNAs. Also, sensitivity levels of the MMChips, as well as dynamic range of the MMChips, are measured by linear analysis using a series of dilutions of probes with different concentration. Additionally, hybridization experiments of all types of samples are repeated for three times to compare differences among inter-chip (triplicates for probe) and inter-experiment (triplicate MMChips), to evaluate reproducibility of the MMChip system. Furthermore, several time courses are conducted to determine the best detection time, to bring out the maximum presentation of signals distributed on the MMChips. Additionally, real time-PCR is performed to validate 20 miRNAs detected by the MMChip system, to estimate reliability rate of the MMChips system. Finally, main features of an MMChip probed by radioactive label were compared to main features of an MMChip probed by DIG label.

Results

The MMChip system has conceptual similarities to DNA microarray systems designed for the study of transcriptional expression (i.e., mRNA levels); however, the sample (target) preparation, the probe preparation, and the labeling and detection methods are very different. To establish an accurate, sensitive, and reliable array platform to globally profile gene regulation of miRNA, the MMChip and methods of the present invention were optimized, controls were provided, and optimization of systematic MMChips performance was conducted.

Quality and quantity control of microRNA. The miRNAs are contained within certain a certain ration of small RNAs, extracted from total RNA. Improper manipulation can cause total RNA degradation, which can increase potential mistakes in the estimation of small RNA quantity. To prevent such mistake from occurring, RNase inhibitor is added during small RNA extraction in order to reduce total RNA degradation, and then total RNA quality is checked on agarose gel before starting small RNA isolation. Such a protocol provides small RNAs with accurate quantity and good quality. In addition, small RNA extraction protocol is further optimized by increasing salt concentration, extending incubation time, and decreasing incubation temperature, which enhances the yield of small RNA extraction. When total RNA amount was rich (about 200 ug to about 2 mg) the small RNA recovery rate can reach as high as about 15% to about 17% out of total RNA, which is higher than that of total RNA obtained by using other methods, for example Ambion's miRNA extraction kit (Ambion, Inc., Austin, Tex.). When total RNA quantity is limited (about 20 ug to about 30 ug) the small RNA recover rate is about 2 ug to about 3 ug, which is sufficient to obtain ideal and global signal presentation on MMChips.

Modification of Dig End labeling and hybridization conditions. There are several approaches to label small RNA and miRNA based on end labeling, amplification, and locked nucleic acid, and most frequently by using radioactive and fluorescent labeling methods. A simple, safe, and efficient labeling method makes use of the DIG labeling kit and DIG hybridization reagents, available from Roche Diagnostics Corporation (Indianapolis, Ind.). However, the protocols are standardized for nucleotide probe preparation and hybridization assay in Northern blot. In addition, the genomic microRNAs are tissue specific, and expression levels of miRNAs are different. Therefore, efforts are made to determine the most beneficial conditions of DIG labeling and hybridization for DIG labeled probes for the MMChip system, which has not previously been described.

The detection capacity of the MMChip can be enhanced by increasing the concentrations of probes printed on chips, and by prolonging hybridization time and detection time. It is demonstrated that the optimal quantity of global small RNAs used in DIG labeling for each kind of tissues/cells varies between about 2 μg and about 5 μg. When the amount of small RNA is less than about 1 ug, longer hybridization and detection times are desirable to obtain more complete information. It is found that, by testing different end labeling methods, DIG-labeling generates signals that are stronger and more clear, as compared to gamma-P³³ and alpha-P³² labeling, although the gamma-P³³ and alpha-P³² labeling tends to present a more dynamic range.

MMChip performance: A generic and multi-functional control system designed to monitor non specific hybridization, RNA degradation, signal saturation and chips orientation is provided. Seven oligonucleotides having randomized sequences are generated for use as negative controls. By repeatedly testing the negative controls on MMChips specific for different species, it is determined that the probes of SEQ ID NOS: 375-379 are particularly useful as negative controls because they consistently fail to bind labeled sample, resulting in no signal appearing on the MMChips. No total RNA degradation signals are found by anti-sense strands of house keeping genes, which suggests that small RNA does not contain any small fragment coming from total RNA. In addition, positive controls (SEQ ID NOS: 367 and 371) are designed and provided as part of the control system. A signal associated with the positive controls indicate successful hybridization. Additionally, the positive controls can be immobilized on the MMChip in specific locations, providing a useful index of orientation of the MMChips. The serial dilutions of the positive controls can be included on the MMChip to control for saturation.

Specificity of MMChips. Specificity of MMChips is tested by reciprocal hybridizations between miRNAs mir181b and mir222. The mistake rate of cross hybridization is evaluated by the arrays printed with the probes with perfect matched, single and multiple mismatched miRNAs. Under the probes labeled at very high concentration of 100 ng in assay, cross hybridization might happen to 1 and 2 mismatched miRNAs, which presents different signal intensity. Nevertheless, when concentration of probes is lower and hybridization temperature is higher, the cross hybridization signal disappears.

Sensitivity and Dynamic range of MMChips. Linear analysis is conducted to determine the sensitive and dynamic features of the MMChip system. Fifty (50) pmol, 100 pmol, and 200 pmol of probes are printed on chips, and DIG labeled samples at concentration from 0.00001 pmol/ul to 100 pmol/ul, with 100 increments, are hybridized with probes on the membranes. The minimum signal intensity detectable by the probes at concentration of 200 pmol/ul printed on chips is about 100 fmol. The dynamic arrangement of the MMChip is between 10 pmol and 0.0001 pmol, suggesting that the intensity difference between the strongest and the weakest signals are 10,000 folds. The strongest signal becomes saturated after 6 hours when DIG labeled probe concentration is as high as 100 pmol. The linear analysis comparison between radioactive labeling and DIG labeling shows that DIG detection is not as dynamic as that of radioactive detection, limited mainly by the image processing capacity for DIG detection. To get over this potential limitation of DIG labeling, two time course strategies are used, i.e., using the same probes to do two hybridization assays, but stopping detection time at 24 hour and 48 hours respectively. The signals presenting differences detected by the MMChips where detection was stopped at 24-hour chips, and those where detection was stopped at 48-hours do not have much overlap. The MMChips where detection was stopped at 24-hour chips are characterized by presenting many weaker signals and very little saturated signals, but also with some signals not emerging on chips yet. On the other hand, the MMChips where detection was stopped at 48-hours included increased visualization of the weaker signals (25˜30%) and more saturated signals (2˜4%). The complementary information fills any information gap that results from a limited dynamic range.

Accuracy and Reproducibility of MMChips. The differences between each two of triplicates of chips (biological triplicates) representing each sample (status or condition) is evaluated. The average correlation in inter-MMChips is calculated by using MS-Excel®, presenting an array-array correlation as high as 96.5% (SD=±0.06%) for 24 hour detection and 92.2% (SD=±3.9%) for 48 hour detection. The reproducibility of the MMChips is established at about 88.6% to about 95.3% correlation rate between each two of the three repeated experiments (experiment triplicates)

Reliability of MMChips (established by real time PCR validation) Taqman® Assays (Applied Biosystems, Foster City, Calif.) are used to do real-time validation, to aid in discriminating cross hybridization between homologous miRNA of same family with only 1 or 2 mismatched bases in sequences.

Global profiling gene regulation of miRNA using MMChips. With optimized MMChips system a global profiling of miRNAs is initiated in fibroblast cells and lymphocytes, as well as that in young vs. old fibroblast and control vs. treated lymphocytes. The MMChips include probes for 459 known human miRNAs and 19 novel human miRNAs, discovered by the inventors. After overnight hybridization and 24 hour detection, the MMChips present distinct expression pattern differences between WI38 fibroblast cells and lymphocytes. Comparison of young replicative vs. senescent cells and control vs. treated lymphocytes also reveals status differences. Certain miRNAs are up-regulated and other miRNAs are down-regulated in senescent cells compared with young replicative cells. Certain miRNAs are over expressed but other miRNAs are under expressed in control vs. treated cells. The MMChip data is validated using real time PCR.

One of ordinary skill in the art will recognize that modifications and variations are possible without departing from the teachings of the invention. This description, and particularly the specific details of the exemplary embodiments disclosed, is provided primarily for clearness of understanding and no unnecessary limitations are to be understood therefrom, for modifications and other embodiments will become evident to those skilled in the art upon reading this disclosure and may be made without departing from the spirit or scope of the claimed invention.

Unless otherwise indicated, all numbers expressing quantities of ingredients, properties such as reaction conditions, and so forth used in the Specification and Claims are to be understood as being modified in all instances by the term “about.” Accordingly, unless indicated to the contrary, the numerical parameters set forth in the Specification and Claims are approximations that can vary depending upon the desired properties sought to be determined by the present invention.

Notwithstanding that the numerical ranges and parameters setting forth the broad scope of the invention are approximations, the numerical values set forth in the example sections are reported as precisely as possible. Any numerical value, however, inherently contain certain errors necessarily resulting from the standard deviation found in their respective testing measurements.

### REFERENCES

Throughout this application, various publications are referenced. All such references are incorporated herein by reference, including the references set forth in the following list:
1) Abbott, et al., “The let-7 MicroRNA family members mir-48, mir-84, and mir-241 function together to regulate developmental timing in Caenorhabditis elegans,” Developmental Cell, Vol. 9, pages 403-414 (September 2005)
2) Altuvia, et al., “Clustering and conservation patterns of human microRNAs,” Nucleic Acids Research, Vol. 33, No. 8, pages 2697-706 (Published online May 12, 2005)
3) Babak, et al., “Probing microRNAs with microarrays: Tissue specificity and functional inference,” RNA, 10:1813-1819 (2004)
4) Baehrecke, “MiRNAs: Micro Mangers of Programmed Cell Death,” Current Biology, Vol. 13, pages R473-475 (Jun. 17, 2003)
5) Barad, Omer, et al., “MicroRNA expression detected by oligonucleotide microarrays: System establishment and expression profiling in human tissues,” Genome Research, 14:2486-2494 (2004)
6) Bartel, et al., “MicroRNAs: Genomics, Biogenesis, Mechanism, and Function,” Cell, Vol. 116, pages 281-297 (Jan. 23, 2004)
7) Baskerville, et al., “Microarray profiling of MicroRNAs reveals frequent coexpression with neighboring miRNAs and host genes,” RNA, 11:241-247 (2005)
8) Bengert, et al., “Current efforts in the analysis of RNAi and RNAi target genes,” Briefings in Bioinformatics, Vol. 6, No. 1, pages 72-85 (March 2005)
9) Bennasser, Le, et al., “HIV-I encoded candidate Micro-RNAs and their cellular targets,” Retrovirology, 1:43 (Dec. 15, 2004)
10) Bentwich, et al., Identification of hundreds of conserved and non conserved human microRNAs,” Nature Genetics., Vol. 37, No. 7, page 766-770 (July 2005)
11) Bottoni, et al., “miR-15a and miR-16-1 down-regulation in pituitary adenomas,” Journal of Cellular Physiology, 204:280-285 (2005)
12) Boutla, et al., “Developmental defects by antisense-mediated inactivation of micro-RNAs 2 and 13 in Drosophila and the identification of putative target genes,” Nucleic Acids Research, Vol. 31, No. 17, pages 4973-4980 (2003)
13) Bruneau, “Tiny brakes for a growing heart,” Nature, Vol. 435, pages 181-182 (Jul. 14, 2005)
14) Burgler, et al., “Prediction and verification of microRNA targets by Moving Targets, a highly adaptable prediction method,” BMC Genomics, Vol. 6, No. 1, pages 88-99 (Jun. 8, 2005)
15) Cai, et al., “Kaposi's sarcoma-associated herpesvirus expresses an array of viral microRNAs in latently infected cells,” PNAS-USA, Vol. 102, No. 15, pages 5570-5575 (Apr. 12, 2005)
16) Caldas, et al, “Sizing up miRNAs as cancer genes,” Nature Medicine, Vol. 11, No. 7, pages 712-174 (July 2005)
17) Calin, et al., “Human microRNA genes are frequently located at fragile sites and genomic regions involved in cancers,” PNAS-USA, Vol. 101, No. 9, pages 2999-304 (Mar. 2, 2004)
18) Chan, et al., “MicroRNA-21 is an antiapoptotic factor in human glioblastoma cells,” Cancer Research, Vol. 65, No. 14, pages 6029-6033 (Jul. 15, 2005)
19) Chapman, et al., “Viral RNA silencing suppressors inhibit the microRNA pathway at an intermediate step,” Genes & Development, Vol. 18, No. 10, pages 1179-1186 (2004)
20) Chen, et al, “Real-time quantification of microRNAs by stem-loop RT-PCR,” Nucleic Acids Res. Vol. 33, page 179 (2005)
21) Cheng, et al., “Antisense inhibition of human miRNAs and indications for an involvement of miRNA in cell growth and apoptosis,” Nucleic Acids Research, Vol. 33, No. 4, pages 1290-1297 (2005)
22) Chen, et al., “MicroRNAs modulate hematopoietic lineage differentiation,” Science Magazine, Vol. 303, pages 83-86 (Jan. 2, 2004)
23) Ciafre, et al., “Extensive modulation of a set of microRNAs in primary glioblastoma,” Biochem. Biophys Res Commun., Vol. 334, No. 4, pages 1315-1358 (July 2005)
24) Cimmino, et al., “miR-15 and miR-16 induce apoptosis by targeting BCL2,” PNAS-USA, Vol. 102, No. 39, pages 13944-13949 (Sep. 27, 2005)
25) Costa, et al., “Non-coding RNAs: New players in eukaryotic biology,” Science Direct, Gene Vol. 357, No. 2, pages 83-94 (September, 2005)
26) Croce, et al., “miRNAs, cancer, and stem cell division,” DOI, Vol. 122, No. 1, pages 6-7 (July 2005)
27) Doench, et al., “Specificity of microRNA target selection in translational repression,” Genes & Development, Vol. 18, No. 5, pages 504-511 (March, 2004)
28) Dresios, et al, “Cold stress-induced protein Rbm3 binds 60S ribosomal subunits, alters microRNA levels, and enhances global protein synthesis,” PNAS-USA, Vol. 102, No. 6, pages 1865-1870 (Feb. 8, 2005)
29) Elbashir, et al., “RNA interference is mediated by 21- and 22-nucleotide RNAs,” Genes Dev. Vol. 15, pages 188-200 (2001)He, et al., “MicroRNAs: Small RNAs with a big role in gene mutation,” Nature, Vol. 5, pages 522-532 (July 2004)
30) Esau, et al., “MicroRNA-143 regulates adipocyte differentiation,” The Journal of Biological Chemistry, Vol. 279, No. 50, pages 52361-52365 (Dec. 10, 2004)
31) Finnegan, et al., “The small RNA world,” Journal of Cell Science 116, pages 1489-4693 (2003)
32) Gottesman, “Micros for microbes: non-coding regulatory RNAs in bacteria,” Trends in Genetics, Vol. 21, No. 7 pages 399-404 (July 2005)
33) Grün, et al., “microRNA target predictions across seven Drosophila species and comparison to mammalian targets,” PLOS Computational Biology, Vol. 1, No. 1, pages 51-66 (June 2005)
34) Guenther, et al., “Global and Hox-specific roles for the MLL1 methyltransferase,” PNAS-USA, Vol. 102, No. 24, pages 8603-8608 (Jun. 14, 2005)
35) Haase, et al., “TRBP, a regulator of cellular PKR and HIV-1 virus expression, interacts with Dicer and functions in RNA silencing,” EMBO Reports, Vol. 6, No. 10, pages 961-967 (June 2005)
36) Hammond, et al., “An RNA-directed nuclease mediates post-transcriptional gene silencing in Drosophila cells,” Nature, Vol. 404, pages 293-296 (2000)
37) He, et al., “A microRNA polycistron as a potential human oncogene” Nature, Vol. 435, No. 7043, pages 828-833 (June 2005)
38) Iorio, et al., “MicroRNA gene expression deregulation in human breast cancer,” Cancer Research, Vol. 65, No. 16, pages 7065-7070 (Aug. 15, 2005)
39) Jiang, et al., “Real-time expression profiling of microRNA precursors in human cancer cell lines,” Nucleic Acids Research, Vol. 33, No. 17, pages 5394-5403 (April 2005)
40) Jin, et al., “Biochemical and genetic interaction between the fragile X mental retardation protein and the microRNA pathway,” Nature Neuroscience, Vol. 7, No. 2, pages 113-117 (February 2004)
41) Johnson, et al., “A microRNA controlling left/right neuronal asymmetry in Caenorhabditis elegans,” Nature, Vol. 426, page 845-849 (December 2003)
42) Jopling, et al., “Modulations of Hepatitis C Virus RNA abundance by a liver-specific MicroRNA,” Science, Vol 309, pages 1577-1581 (Sep. 2, 2005)
43) Kettering, et al., “What's New about RNAi? Meeting on siRNAs and miRNAs,” EMBO Reports, Vol. 5, No. 8, pages 762-765 (Jul. 23, 2004)
44) Kosik, et al., “The Elegance of the MicroRNAs: A Neuronal Perspective,” Neuron, Vol. 47, pages 779-782 (Sep. 15, 2005)
45) Lagos-Quintana, et al., “Identification of novel genes coding for small expressed RNAs,” Science Vol. 294, pages 853-858 (2001)
46) Lau, et al., “An abundant class of tiny RNAs with probable regulatory roles in Caenorhabditis elegans,” Science, Vol. 294, pages 858-862 (2001)
47) Lau, et al., “An abundant class of tiny RNAs with probable regulatory roles in Caenorhabditis elegans,” Science, Vol. 294, pages 858-862 (2001)
48) Leclellier, et al., “A cellular MicroRNA mediates antiviral defense in human cells,” Science, Vol. 308, pages 557-560 (Apr. 22, 2005)
49) Lee, et al., “The C. elegans heterochronic gene lin-4 encodes small RNAs with antisense complementarity to lin-14,” Cell Vol. 75, pages 843-854 (2001)
50) Lee, et al., “Depletion of human Micro-RNA miR-125b reveals that it is critical for the proliferation of differentiated cells but not for the down-regulation of putative targets during differentiation,” The Journal of Biological Chemistry, Vol. 280, No. 17, pages 16635-16641 (Apr. 29, 2005)
51) Liang, et al., “A small yeast RNA inhibits HCV IRES mediated translation and inhibits replication of poliovirus in vivo,” World Journal of Gastroenterology, vol. 9, No. 5, pages 1008-1013 (2003)
52) Lim, et al., “Microarray analysis shows that some microNRAs downregulate large numbers of target mRNAs,” Nature, Vol. 433, pages 769-773 (Feb. 17, 2005)
53) Lim, et al., “Vertebrate microRNA genes,” Science Vol. 299, page 1540 (2003)
54) Liu, et al., “An oligonucleotide microchip for genome-wide microRNA profiling in human and mouse tissues,” PNAS-USA, Vol 101, No. 26, pages 9740-9744 (Jun. 29, 2004)
55) Lu, et al., “Adenovirus VA1 noncoding RNA can inhibit small interfering RNA and MicroRNA biogenesis,” Journal of Virology, Vol. 78, No. 23, pages 12668-12876 (December 2004)
56) Lu, et al., “MicroRNA expression profiles classify human cancers,” Nature, Vol. 435, pages 834-838 (Jun. 9, 2005)
57) Lund, et al., “Nuclear export of microRNA precursors,” Science, Vol. 303, pages 95-98 (2004)
58) Meltzer, “Small RNAs with big impacts,” Nature, Vol. 435, pages 745-746 (June 2005)
59) Michlewski, et al., “Molecular architecture of CAG repeats in human disease related transcripts,” Journal of Molecular Biology, Vol. 340, No. 4, pages 665-679 (2004)
60) Miska, “How MicroRNAs control cell division, differentiation and death,” Curr Opin Genet Dev., Vol. 15, No. 5, pages 563-568 (October, 2005)
61) Monticelli, et al., “MicroRNA profiling of the murine hematopoietic system,” Genome Biology, Vol. 6, Issue 8, page R71 (2005)
62) Nakahara, et al., “Targets of microRNA regulation I: the Drosophila oocyte proteome,” PNAS-USA, Vol. 102, No. 34, pages 12023-12028 (Aug. 23, 2005)
63) Nelson, et al., “miRNP:mRNA association in polyribosomes in a human neuronal cell line, RNA Journal, Vol. 10, No. 3, pages 387-394 (2004)
64) Novina, et al., “The RNAI revolution, Nature, Vol. 430, pages 161-164 (Jul. 8, 2004)
65) O'Donnell, et al., “c-Myc-regulated microRNAs modulate E2F1 expression,” Nature, Vol 435, pages 839-843 (Jun. 9, 2005)
66) Omoto, et al., “Regulation of human immunodeficiency virus 1 transcription by nef micron RNA,” Journal of General Virology, Vol. 86, pages 751-755 (2005)
67) Östberg, et al., “The etiological agent of lyme disease, Borrelia burgdorferi, appears to contain only a few small RNA molecules,” Journal of Bacteriology, Vol. 186, No. 24, pages 8472-8477 (2004)
68) Poy, et al., “A pancreatic islet-specification microRNA regulates insulin secretion,” Nature, Vol. 432, pages 226-230 (November 2004)
69) Reinhart, et al., “The 21-nucleotide let-7 RNA regulates developmental timing in Caenorhabditis elegans,” Nature 403, pp. 901-906 (2000).
70) Ruvkun, et al., “The 20 Years It Took to Recognize the Importance of Tiny RNAs,” Cell, Vol. S116, pages S93-S96 (Jan. 23, 2004)
71) Schmittgen, et al., “A high-throughput method to monitor the expression of microRNA precursors,” Nucleic Acids Research, Vol. 32, No. 4 e43 (Published online, Feb. 25, 2004)
72) Semov, et al., “Microarray analysis of E-Box Binding-Related Gene Expression in young and Replicatively Senescent Human Fibroblasts,” Analytical Biochemistry Analytical Biochemistry, Vo. 302, pages 38-51 (2002)
73) Smalheiser, et al., “Mammalian microRNAs derived from genomic repeats,” Trends in Genetics, Vol. 21, No. 6, pages 322-326 (June 2005)
74) Smirnova, et al., “Regulation of miRNA expression during neural cell specification,” European Journal of Neuroscience, Vol. 21, pages 1469-1477 (2005)
75) Smith, “Genomics: Big Tasks for Small Molecules,” Nature, Vol. 435, No. 7044, page 991 (June 2005)
76) Smith, “Genomics: Getting Down to Details,” Nature, Vol. 435, No. 7044, pages 991-994 (June 2005)
77) Soldan, et al., “La Cross Virus nonstructural protein NSs counteracts the effects of short interfering RNA,” Journal of Virology, Vol. 79, No. 1, pages 234-244 (January 2005)
78) Sontheimer, et al., “Silence from within: Endogenous siRNAs and miRNAs,” Cell, Vol. 122, pages 9-12 (Jul. 15, 2005)
79) Stegmeier, et al., “A lentiviral microRNA-based system for single-copy polymerase II-regulated RNA interference in mammalian cells,” PNAS-USA, Vol. 102, No. 37, pages 13212-13217 (Sep. 13, 2005)
80) Suh, et al., “Human embryonic stem cells express a unique set of microRNAs,” Dev. Biol., Vol. 270, No. 2, pages 488-498 (Jun. 15, 2004)
81) Sullivan, et al., “SV40-encoded microRNAs regulate viral gene expression and reduce susceptibility to cytotoxic T cells,” Nature, Vol. 435, pages 682-686 (June 2005)
82) Sun, et al., “Development of a micro-array to detect human and mouse microRNAs and characterization of expression in human organs,” Nucleic Acids Research, Vol. 32, No. 22, e188 (published online Dec. 22, 2004)
83) Takamizawa, et al., “Reduced expression of the let-7 MicroRNAs in human lung cancers in association with shortened postoperative survival,” Cancer Research, Vol. 64, pages 3753-3756 (Jun. 1, 2004)
84) Takeda, et al., “A plant RNA virus suppresses RNA silencing through viral RNA replication,” EMBO Journal, Vol. 24, pages 3147-3157 (2005)
85) Tanno, et al., “Silencing of endogenous IGFBP-5 by micro RNA interference affects proliferation, apoptosis and differentiation of neuroblastoma cells,” Cell Death and Differentiation, Vol. 12, pages 213-223 (2005)
86) Thomson, et al., “A custom microarray platform for analysis of microRNA gene expression,” Nat. Meth. 1, pp. 47-53 (2004).
87) Válóczi, et al., “Sensitive and specific detection of microRNAs by northern blot analysis using LNA-modified oligonucleotide probes,” Nucleic Acids Research, Vol. 32, No. 22, e175 (published online Dec. 14, 2004)
88) Voinnet, “Induction and suppression of RNA silencing: Insights from viral infections,” Nature Review of Genetics, Vol. 6, pages 206-221 (March 2005—online)
89) Weber, “New human and mouse microRNA genes found by homology search,” FEBS Letters, Vol. 272, pages 59-73 (2004)
90) Wienholds, et al., “MicroRNA function in animal development,” FEBS Letters, Vol. 579, pages 5911-5922 (2005)
91) Wightman, et al., “Posttranscriptional regulation of the heterochronic gene lin-14 by lin-4 mediates temporal pattern formation in C. elegans,” Cell Vol. 75, pages 855-862 (1993)
92) Xu, et al., “The Drosophila MicroRNA Mir-14 suppresses cell death and is required for normal fat metabolism,” Current Biology, Vol. 13, pages 790-795 (Apr. 29, 2003)
93) Xu, et al., “MicroRNAs and the regulation of cell death,” Trends in Genetics, Vol. 20, No. 12, pages 617-624 (December 2004)
94) Yi, et al., “Exportin-5 mediates the nuclear export of pre-microRNAs and short hairpin RNAs,” Genes Dev Vol. 17, pages 3011-3016 (2003)
95) Yi, et al., “Overexpression of Exportin-5 enhances RNA interference mediated by short hairpin RNAs and microRNAs,” RNA Journal, Vol. 11, pages 220-226 (2005)
96) Zhao, et al., “Serum response factor regulates a muscle-specific microRNA that targets Hand2 during cardiogenesis,” Nature, Vol. 436, pages 214-220 (Jul. 14, 2005)

What is claimed is:

1. An array of oligonucleotide probes for identifying micro-RNAs in a sample, comprising:
probes that each selectively bind a mature micro-RNA; and
a platform, wherein the probes are immobilized on the platform;
wherein
at least one probe selectively binds a human micro-RNA selected from human micro-RNAs comprising sequences of SEQ ID NOS: 1-19; or
at least one probe is selected from probes comprising sequences of SEQ ID NOS: 39-57.

2-30. (canceled)

31. The array of claim 1, and further comprising
at least one randomly-generated sequence used as a negative control;
at least one oligonucletide sequence derived from a housekeeping gene, used as a negative control for total RNA degradation;
at least one randomly-generated sequence used as a positive control; and
a series of dilutions of at least one positive control sequence used as saturation controls;
wherein at least one positive control sequence is positioned on the array to indicate orientation of the array.

32. The array of claim 31, wherein the at least one randomly-generated sequence used as a negative control is selected from SEQ ID NOS: 375-381; wherein the at least one oligonucletide sequence derived from a housekeeping gene is selected from SEQ ID NOS: 382-389; and wherein the at least one randomly-generated sequence used as a positive control is selected from SEQ ID NOS; 367-374.

33. The array of claim 1, and further comprising at least one randomly-generated sequence used as a negative control.

34. (canceled)

35. The array of claim 1, and further comprising at least one oligonucletide sequence derived from a housekeeping gene, used as a negative control for total RNA degradation.

36. (canceled)

37. The array of claim 1, and further comprising at least one randomly-generated sequence used as a positive control.

38. (canceled)

39. The array of claim 37, and further including a series of dilutions of at least one positive control sequence used as saturation controls.

40. A method of identifying miRNAs in a sample, comprising:
providing a first array according to claim 1;
providing a first labeled miRNA sample;
hybridizing said first labeled miRNA sample with said first array; and
detecting the hybridized miRNAs.

41. The method of claim 40, wherein the miRNA is labeled with DIG, and the miRNA is detected with anti-DIG antibody.

42-54. (canceled)

55. The method of claim 40, and further comprising:
providing a second array according to claim 1, having a template that is the same as that of the first array;
providing a second labeled miRNA sample;
hybridizing said second labeled miRNA sample with said second array;
detecting the hybridized miRNAs; and
comparing the hybridized miRNAs of the first array to the hybridized miRNAs of the second array.

56. The array of claim 1, wherein the array includes probes that selectively bind each of the human micro-RNAs comprising sequences of SEQ ID NOS: 1-19.

57. The array of claim 56, wherein the array further includes at least one probe that selectively binds a human micro-RNA selected from the human micro-RNAs identified in FIG. 1(b).

58. The array of claim 56, wherein the array further includes probes that selectively bind each of the human micro-RNAs identified in FIG. 1(b).

59. The array of claim 1, wherein the array further includes at least one probe that selectively binds a human micro-RNA selected from the human micro-RNAs identified in FIG. 1(b).

60. The array of claim 1, wherein the array includes each of the probes comprising sequences of SEQ ID NOS: 39-57.

61. The array of claim 60, wherein the array further includes at least one probe comprising a sequence that is complementary to a human micro-RNA identified in FIG. 1(b).

62. The array of claim 60, wherein the array further includes probes comprising sequences that are complementary to each of the human micro-RNAs identified in FIG. 1(b).

63. The array of claim 1, wherein the array further includes at least one probe comprising a sequence that is complementary to a human micro-RNA identified in FIG. 1(b).

64. An array of oligonucleotide probes for identifying micro-RNAs in a sample, comprising:
probes that each selectively bind a mature micro-RNA; and
a platform, wherein the probes are immobilized on the platform;
wherein
at least one probe selectively binds a canine micro-RNA selected from canine micro-RNAs comprising sequences of SEQ ID NOS: 58-160; or
at least one probe is selected from probes comprising sequences of SEQ ID NOS: 264-366.

65. The array of claim 64, wherein the array includes probes that selectively bind each of the canine micro-RNAs comprising sequences of SEQ ID NOS: 58-160.

66. The array of claim 64, wherein the array includes probes that selectively bind at least ten of the canine micro-RNAs comprising sequences of SEQ ID NOS: 58-160.

67. The array of claim 64, wherein the array includes each of the probes comprising sequences of SEQ ID NOS: 264-366.

68. The array of claim 64, wherein the array includes at least ten of the probes comprising sequences of SEQ ID NOS: 264-366.

69. The array of claim 64, and further comprising
at least one randomly-generated sequence used as a negative control;
at least one oligonucletide sequence derived from a housekeeping gene, used as a negative control for total RNA degradation;
at least one randomly-generated sequence used as a positive control; and
a series of dilutions of at least one positive control sequence used as saturation controls;
wherein at least one positive control sequence is positioned on the array to indicate orientation of the array.

70. The array of claim 64, and further comprising at least one randomly-generated sequence used as a negative control.

71. The array of claim 64, and further comprising at least one oligonucletide sequence derived from a housekeeping gene, used as a negative control for total RNA degradation.

72. The array of claim 64, and further comprising at least one randomly-generated sequence used as a positive control.

73. A method of identifying miRNAs in a sample, comprising:
providing a first array according to claim 64;
providing a first labeled miRNA sample;
hybridizing said first labeled miRNA sample with said first array; and
detecting the hybridized miRNAs.

74. The method of claim 73, wherein the miRNA is labeled with DIG, and the miRNA is detected with anti-DIG antibody.

75. The method of claim 73, and further comprising:
providing a second array according to claim 1, having a template that is the same as that of the first array;
providing a second labeled miRNA sample;
hybridizing said second labeled miRNA sample with said second array;
detecting the hybridized miRNAs; and
comparing the hybridized miRNAs of the first array to the hybridized miRNAs of the second array.


SEQUENCE LISTING (389 sequences)

SEQ ID NO: 1 - RNA, 24 nt, Homo sapiens
gucaacaucagaucugauaagacu

SEQ ID NO: 2 - RNA, 21 nt, Homo sapiens
agcggcuccgccauauucaag

SEQ ID NO: 3 - RNA, 21 nt, Homo sapiens
ccucagacacacuuuaucuuc

SEQ ID NO: 4 - RNA, 16 nt, Homo sapiens
ggcccagcacgcuucc

SEQ ID NO: 5 - RNA, 20 nt, Homo sapiens
caauucaaauuaaauuucaa

SEQ ID NO: 6 - RNA, 19 nt, Homo sapiens
uuaaauuucaacuaaguug

SEQ ID NO: 7 - RNA, 18 nt, Homo sapiens
auuucaacuaaguugaaa

SEQ ID NO: 8 - RNA, 20 nt, Homo sapiens
uuccgccggccgccuugcag

SEQ ID NO: 9 - RNA, 19 nt, Homo sapiens
gggacuguaggcacgugcc

SEQ ID NO: 10 - RNA, 18 nt, Homo sapiens
cgugccuacaguuucagg

SEQ ID NO: 11 - RNA, 19 nt, Homo sapiens
gacuuguaggcuacagacu

SEQ ID NO: 12 - RNA, 18 nt, Homo sapiens
ggaauggcagcgaguccg

SEQ ID NO: 13 - RNA, 20 nt, Homo sapiens
cacggucaggguccgaccua

SEQ ID NO: 14 - RNA, 24 nt, Homo sapiens
aggucccggagccguuaucaggug

SEQ ID NO: 15 - RNA, 21 nt, Homo sapiens
caaucacuagugaauucgcgg

SEQ ID NO: 16 - RNA, 19 nt, Homo sapiens
cgggugcuguaggcuuucu

SEQ ID NO: 17 - RNA, 22 nt, Homo sapiens
uaccauguaaacgugguagcga

SEQ ID NO: 18 - RNA, 19 nt, Homo sapiens
cuaccauguaaacguguag

SEQ ID NO: 19 - RNA, 22 nt, Homo sapiens
cuguaggcacgcaccugaaacu

SEQ ID NO: 20 - DNA, 24 bp, Artificial
  Sense DNA Copy of miRNA
gtcaacatcagatctgataagact

SEQ ID NO: 21 - DNA, 21 bp, Artificial
  Sense DNA Copy of miRNA
agcggctccgccatattcaag

SEQ ID NO: 22 - DNA, 21 bp, Artificial
  Sense DNA Copy of miRNA
cctcagacacactttatcttc

SEQ ID NO: 23 - DNA, 16 bp, Artificial
  Sense DNA Copy of miRNA
ggcccagcacgcttcc

SEQ ID NO: 24 - DNA, 20 bp, Artificial
  Sense DNA Copy of miRNA
caattcaaattaaatttcaa

SEQ ID NO: 25 - DNA, 19 bp, Artificial
  Sense DNA Copy of miRNA
ttaaatttcaactaagttg

SEQ ID NO: 26 - DNA, 18 bp, Artificial
  Sense DNA Copy of miRNA
atttcaactaagttgaaa

SEQ ID NO: 27 - DNA, 20 bp, Artificial
  Sense DNA Copy of miRNA
ttccgccggccgccttgcag

SEQ ID NO: 28 - DNA, 19 bp, Artificial
  Sense DNA Copy of miRNA
gggactgtaggcacgtgcc

SEQ ID NO: 29 - DNA, 18 bp, Artificial
  Sense DNA Copy of miRNA
cgtgcctacagtttcagg

SEQ ID NO: 30 - DNA, 19 bp, Artificial
  Sense DNA Copy of miRNA
gacttgtaggctacagact

SEQ ID NO: 31 - DNA, 18 bp, Artificial
  Sense DNA Copy of miRNA
ggaatggcagcgagtccg

SEQ ID NO: 32 - DNA, 20 bp, Artificial
  Sense DNA Copy of miRNA
cacggtcagggtccgaccta

SEQ ID NO: 33 - DNA, 24 bp, Artificial
  Sense DNA Copy of miRNA
aggtcccggagccgttatcaggtg

SEQ ID NO: 34 - DNA, 21 bp, Artificial
  Sense DNA Copy of miRNA
caatcactagtgaattcgcgg

SEQ ID NO: 35 - DNA, 19 bp, Artificial
  Sense DNA Copy of miRNA
cgggtgctgtaggctttct

SEQ ID NO: 36 - DNA, 22 bp, Artificial
  Sense DNA Copy of miRNA
taccatgtaaacgtggtagcga

SEQ ID NO: 37 - DNA, 19 bp, Artificial
  Sense DNA Copy of miRNA
ctaccatgtaaacgtgtag

SEQ ID NO: 38 - DNA, 22 bp, Artificial
  Sense DNA Copy of miRNA
ctgtaggcacgcacctgaaact

SEQ ID NO: 39 - DNA, 24 bp, Artificial
  Complementary Probe of miRNA
agtcttatcagatctgatgttgac

SEQ ID NO: 40 - DNA, 21 bp, Artificial
  Complementary Probe of miRNA
cttgaatatggcggagccgct

SEQ ID NO: 41 - DNA, 21 bp, Artificial
  Complementary Probe of miRNA
gaagataaagtgtgtctgagg

SEQ ID NO: 42 - DNA, 16 bp, Artificial
  Complementary Probe of miRNA
ggaagcgtgctgggcc

SEQ ID NO: 43 - DNA, 20 bp, Artificial
  Complementary Probe of miRNA
ttgaaatttaatttgaattg

SEQ ID NO: 44 - DNA, 19 bp, Artificial
  Complementary Probe of miRNA
caacttagttgaaatttaa

SEQ ID NO: 45 - DNA, 18 bp, Artificial
  Complementary Probe of miRNA
tttcaacttagttgaaat

SEQ ID NO: 46 - DNA, 20 bp, Artificial
  Complementary Probe of miRNA
ctgcaaggcggccggcggaa

SEQ ID NO: 47 - DNA, 19 bp, Artificial
  Complementary Probe of miRNA
ggcacgtgcctacagtccc

SEQ ID NO: 48 - DNA, 18 bp, Artificial
  Complementary Probe of miRNA
cctgaaactgtaggcacg

SEQ ID NO: 49 - DNA, 19 bp, Artificial
  Complementary Probe of miRNA
agtctgtagcctacaagtc

SEQ ID NO: 50 - DNA, 18 bp, Artificial
  Complementary Probe of miRNA
cggactcgctgccattcc

SEQ ID NO: 51 - DNA, 20 bp, Artificial
  Complementary Probe of miRNA
taggtcggaccctgaccgtg

SEQ ID NO: 52 - DNA, 24 bp, Artificial
  Complementary Probe of miRNA
cacctgataacggctccgggacct

SEQ ID NO: 53 - DNA, 21 bp, Artificial
  Complementary Probe of miRNA
ccgcgaattcactagtgattg

SEQ ID NO: 54 - DNA, 19 bp, Artificial
  Complementary Probe of miRNA
agaaagcctacagcacccg

SEQ ID NO: 55 - DNA, 22 bp, Artificial
  Complementary Probe of miRNA
tcgctaccacgtttacatggta

SEQ ID NO: 56 - DNA, 19 bp, Artificial
  Complementary Probe of miRNA
ctacacgtttacatggtag

SEQ ID NO: 57 - DNA, 22 bp, Artificial
  Complementary Probe of miRNA
agtttcaggtgcgtgcctacag

SEQ ID NO: 58 - RNA, 20 nt, Canis familiaris
ccuuccccgccggccuuccc

SEQ ID NO: 59 - RNA, 19 nt, Canis familiaris
aucguagguaucguaggca

SEQ ID NO: 60 - RNA, 17 nt, Canis familiaris
aagcgacgcucagacag

SEQ ID NO: 61 - RNA, 22 nt, Canis familiaris
agccuuccccgacggccuuccc

SEQ ID NO: 62 - RNA, 15 nt, Canis familiaris
gcgcggcgccgggcu

SEQ ID NO: 63 - RNA, 17 nt, Canis familiaris
ggacggugugaggccgg

SEQ ID NO: 64 - RNA, 16 nt, Canis familiaris
gucuucuuuccccgcu

SEQ ID NO: 65 - RNA, 16 nt, Canis familiaris
cccagugcgccccggg

SEQ ID NO: 66 - RNA, 17 nt, Canis familiaris
aagcaacgcucagacag

SEQ ID NO: 67 - RNA, 19 nt, Canis familiaris
cuuccccgccggccuuccc

SEQ ID NO: 68 - RNA, 17 nt, Canis familiaris
agagcgacgcucagaca

SEQ ID NO: 69 - RNA, 28 nt, Canis familiaris
cccggcgugucggaucucauuaucaggc

SEQ ID NO: 70 - RNA, 17 nt, Canis familiaris
agcggaggaaaagaaac

SEQ ID NO: 71 - RNA, 24 nt, Canis familiaris
gcccacgcaacccaggcaauuaaa

SEQ ID NO: 72 - RNA, 19 nt, Canis familiaris
agugacuagguauggugca

SEQ ID NO: 73 - RNA, 34 nt, Canis familiaris
gcaccucgcacacccggcacgauuagcaggugcc

SEQ ID NO: 74 - RNA, 25 nt, Canis familiaris
ugucaggcacgcacgcauguaaacu

SEQ ID NO: 75 - RNA, 19 nt, Canis familiaris
uugauagggcagacguguc

SEQ ID NO: 76 - RNA, 19 nt, Canis familiaris
acuguagcgaccacgugca

SEQ ID NO: 77 - RNA, 18 nt, Canis familiaris
ggagacagugaagggcug

SEQ ID NO: 78 - RNA, 19 nt, Canis familiaris
uguccauggccaccguccu

SEQ ID NO: 79 - RNA, 17 nt, Canis familiaris
aagucagaaucccgccc

SEQ ID NO: 80 - RNA, 22 nt, Canis familiaris
gcgcgccgcucgccggccgacu

SEQ ID NO: 81 - RNA, 24 nt, Canis familiaris
agugggggacugcguucgcgcuuu

SEQ ID NO: 82 - RNA, 16 nt, Canis familiaris
gccgggcuccccgggu

SEQ ID NO: 83 - RNA, 21 nt, Canis familiaris
gccuuccccgccggccuuccc

SEQ ID NO: 84 - RNA, 17 nt, Canis familiaris
agcccggggcgcacugg

SEQ ID NO: 85 - RNA, 24 nt, Canis familiaris
cucccucggccccgggauucggcg

SEQ ID NO: 86 - RNA, 26 nt, Canis familiaris
aucguaggauaucguaggcacgugcc

SEQ ID NO: 87 - RNA, 25 nt, Canis familiaris
cacggcacacagaaacaguaggcac

SEQ ID NO: 88 - RNA, 16 nt, Canis familiaris
ugggagcgggcgggcu

SEQ ID NO: 89 - RNA, 18 nt, Canis familiaris
acgggugacggggaaucu

SEQ ID NO: 90 - RNA, 23 nt, Canis familiaris
gaggcccgaucggcuguaggcac

SEQ ID NO: 91 - RNA, 20 nt, Canis familiaris
ccgacggcgcgacccuugca

SEQ ID NO: 92 - RNA, 16 nt, Canis familiaris
ggaacgucgucggguc

SEQ ID NO: 93 - RNA, 17 nt, Canis familiaris
ggccgccgcguccgucg

SEQ ID NO: 94 - RNA, 19 nt, Canis familiaris
cccccgcucccgggagguc

SEQ ID NO: 95 - RNA, 17 nt, Canis familiaris
ccggccucacaccgucc

SEQ ID NO: 96 - RNA, 16 nt, Canis familiaris
ccccccggcccucccg

SEQ ID NO: 97 - RNA, 21 nt, Canis familiaris
cccagccgcggcgcgcgccca

SEQ ID NO: 98 - RNA, 20 nt, Canis familiaris
agcuccaccuccccggcgcg

SEQ ID NO: 99 - RNA, 19 nt, Canis familiaris
ugcuugacgaccggugcac

SEQ ID NO: 100 - RNA, 27 nt, Canis familiaris
agugcccgggcccccuauaacaggugc

SEQ ID NO: 101 - RNA, 27 nt, Canis familiaris
uggcgacacaccccccccgcacuaaca

SEQ ID NO: 102 - RNA, 29 nt, Canis familiaris
ggcggcuacgggccuaaaaaggugcuaua

SEQ ID NO: 103 - RNA, 19 nt, Canis familiaris
ggacggugugaggccggcu

SEQ ID NO: 104 - RNA, 17 nt, Canis familiaris
cggcggugggggaggcu

SEQ ID NO: 105 - RNA, 25 nt, Canis familiaris
agcggggaaagaagacccuguugag

SEQ ID NO: 106 - RNA, 19 nt, Canis familiaris
guggggcccgaagcguucu

SEQ ID NO: 107 - RNA, 18 nt, Canis familiaris
cgggagggccggggggcu

SEQ ID NO: 108 - RNA, 17 nt, Canis familiaris
acgccgugaccaaagcu

SEQ ID NO: 109 - RNA, 18 nt, Canis familiaris
aggagggccgcugcggcu

SEQ ID NO: 110 - RNA, 24 nt, Canis familiaris
cagugugccucgggcuguaggcac

SEQ ID NO: 111 - RNA, 18 nt, Canis familiaris
ggcggcggcggcgacucu

SEQ ID NO: 112 - RNA, 22 nt, Canis familiaris
ccguagcgguccuguaggcacg

SEQ ID NO: 113 - RNA, 21 nt, Canis familiaris
cuuuggguuccggggggagcu

SEQ ID NO: 114 - RNA, 25 nt, Canis familiaris
acagugcgccccgggcuguaggcac

SEQ ID NO: 115 - RNA, 17 nt, Canis familiaris
ccuccccgccccccgcc

SEQ ID NO: 116 - RNA, 22 nt, Canis familiaris
gcgccgcucgccggccgaggcu

SEQ ID NO: 117 - RNA, 16 nt, Canis familiaris
gcgggagaccggggcu

SEQ ID NO: 118 - RNA, 16 nt, Canis familiaris
ggucgucgccgccacg

SEQ ID NO: 119 - RNA, 19 nt, Canis familiaris
agaggucuuggggccgaaa

SEQ ID NO: 120 - RNA, 22 nt, Canis familiaris
uaugaagcgcuuggccuuguca

SEQ ID NO: 121 - RNA, 19 nt, Canis familiaris
ugcccgggcccccuguuca

SEQ ID NO: 122 - RNA, 26 nt, Canis familiaris
gaugcugcgagguguuugcgaagugc

SEQ ID NO: 123 - RNA, 24 nt, Canis familiaris
uccuuccccgaccggccuuucccu

SEQ ID NO: 124 - RNA, 18 nt, Canis familiaris
gggugcuguaggcuuucu

SEQ ID NO: 125 - RNA, 20 nt, Canis familiaris
uaugaacgcuuggccuauca

SEQ ID NO: 126 - RNA, 19 nt, Canis familiaris
ccccccccacguuucaagu

SEQ ID NO: 127 - RNA, 18 nt, Canis familiaris
cgggcgagacgggccggu

SEQ ID NO: 128 - RNA, 19 nt, Canis familiaris
gggaaggccggcggggaag

SEQ ID NO: 129 - RNA, 23 nt, Canis familiaris
cgccgaaucccggggccgaggcu

SEQ ID NO: 130 - RNA, 20 nt, Canis familiaris
agcgacgcucagacaggcgu

SEQ ID NO: 131 - RNA, 19 nt, Canis familiaris
ggugccuucucuuuucaga

SEQ ID NO: 132 - RNA, 18 nt, Canis familiaris
aaagcgggcgucgucccu

SEQ ID NO: 133 - RNA, 20 nt, Canis familiaris
uugucaggggugcgaugcca

SEQ ID NO: 134 - RNA, 24 nt, Canis familiaris
aggauggccgagcuguaggcacgu

SEQ ID NO: 135 - RNA, 20 nt, Canis familiaris
aagagggacggccgggggcu

SEQ ID NO: 136 - RNA, 23 nt, Canis familiaris
uaaaagcacgugggcagauauca

SEQ ID NO: 137 - RNA, 17 nt, Canis familiaris
gucugagcgucgcuucu

SEQ ID NO: 138 - RNA, 16 nt, Canis familiaris
agcaccuguaauugga

SEQ ID NO: 139 - RNA, 17 nt, Canis familiaris
uaaugauccuuccgcag

SEQ ID NO: 140 - RNA, 22 nt, Canis familiaris
gcacgcaugaaacuguaaggca

SEQ ID NO: 141 - RNA, 16 nt, Canis familiaris
ccggggagguagugcu

SEQ ID NO: 142 - RNA, 20 nt, Canis familiaris
cgaugugauuucugcccacu

SEQ ID NO: 143 - RNA, 21 nt, Canis familiaris
agaaucccgcccaggcggaaa

SEQ ID NO: 144 - RNA, 18 nt, Canis familiaris
acuguaggcaccaucaau

SEQ ID NO: 145 - RNA, 18 nt, Canis familiaris
aggcccgagccgccugcu

SEQ ID NO: 146 - RNA, 22 nt, Canis familiaris
aaggagucuaacacgugcgccu

SEQ ID NO: 147 - RNA, 24 nt, Canis familiaris
aaaugccucgucacuguaggcacg

SEQ ID NO: 148 - RNA, 17 nt, Canis familiaris
aguggugcauugaccgg

SEQ ID NO: 149 - RNA, 22 nt, Canis familiaris
guguuagagccgucgcuucuag

SEQ ID NO: 150 - RNA, 17 nt, Canis familiaris
ucgcggcguauucgucc

SEQ ID NO: 151 - RNA, 17 nt, Canis familiaris
gguaucuccccugccag

SEQ ID NO: 152 - RNA, 18 nt, Canis familiaris
agaggcccgacccugcuu

SEQ ID NO: 153 - RNA, 26 nt, Canis familiaris
gcucaacagggucuucuuuccccgcu

SEQ ID NO: 154 - RNA, 16 nt, Canis familiaris
uggugaccccgacgug

SEQ ID NO: 155 - RNA, 16 nt, Canis familiaris
auucuuuuccaccgcu

SEQ ID NO: 156 - RNA, 23 nt, Canis familiaris
augcaccugaaaacuguaggcac

SEQ ID NO: 157 - RNA, 19 nt, Canis familiaris
acacccgccgcgggccuuc

SEQ ID NO: 158 - RNA, 16 nt, Canis familiaris
ggggcgaagcuaccau

SEQ ID NO: 159 - RNA, 17 nt, Canis familiaris
auggcacacuuugacca

SEQ ID NO: 160 - RNA, 21 nt, Canis familiaris
ucgauugccgaagcaauaauu

SEQ ID NO: 161 - DNA, 20 bp, Artificial
  Sense DNA Copy of miRNA
ccttccccgccggccttccc

SEQ ID NO: 162 - DNA, 19 bp, Artificial
  Sense DNA Copy of miRNA
atcgtaggtatcgtaggca

SEQ ID NO: 163 - DNA, 17 bp, Artificial
  Sense DNA Copy of miRNA
aagcgacgctcagacag

SEQ ID NO: 164 - DNA, 22 bp, Artificial
  Sense DNA Copy of miRNA
agccttccccgacggccttccc

SEQ ID NO: 165 - DNA, 15 bp, Artificial
  Sense DNA Copy of miRNA
gcgcggcgccgggct

SEQ ID NO: 166 - DNA, 17 bp, Artificial
  Sense DNA Copy of miRNA
ggacggtgtgaggccgg

SEQ ID NO: 167 - DNA, 16 bp, Artificial
  Sense DNA Copy of miRNA
gtcttctttccccgct

SEQ ID NO: 168 - DNA, 16 bp, Artificial
  Sense DNA Copy of miRNA
cccagtgcgccccggg

SEQ ID NO: 169 - DNA, 17 bp, Artificial
  Sense DNA Copy of miRNA
aagcaacgctcagacag

SEQ ID NO: 170 - DNA, 19 bp, Artificial
  Sense DNA Copy of miRNA
cttccccgccggccttccc

SEQ ID NO: 171 - DNA, 17 bp, Artificial
  Sense DNA Copy of miRNA
agagcgacgctcagaca

SEQ ID NO: 172 - DNA, 28 bp, Artificial
  Sense DNA Copy of miRNA
cccggcgtgtcggatctcattatcaggc

SEQ ID NO: 173 - DNA, 17 bp, Artificial
  Sense DNA Copy of miRNA
agcggaggaaaagaaac

SEQ ID NO: 174 - DNA, 24 bp, Artificial
  Sense DNA Copy of miRNA
gcccacgcaacccaggcaattaaa

SEQ ID NO: 175 - DNA, 19 bp, Artificial
  Sense DNA Copy of miRNA
agtgactaggtatggtgca

SEQ ID NO: 176 - DNA, 34 bp, Artificial
  Sense DNA Copy of miRNA
gcacctcgcacacccggcacgattagcaggtgcc

SEQ ID NO: 177 - DNA, 25 bp, Artificial
  Sense DNA Copy of miRNA
tgtcaggcacgcacgcatgtaaact

SEQ ID NO: 178 - DNA, 19 bp, Artificial
  Sense DNA Copy of miRNA
ttgatagggcagacgtgtc

SEQ ID NO: 179 - DNA, 19 bp, Artificial
  Sense DNA Copy of miRNA
actgtagcgaccacgtgca

SEQ ID NO: 180 - DNA, 18 bp, Artificial
  Sense DNA Copy of miRNA
ggagacagtgaagggctg

SEQ ID NO: 181 - DNA, 19 bp, Artificial
  Sense DNA Copy of miRNA
tgtccatggccaccgtcct

SEQ ID NO: 182 - DNA, 17 bp, Artificial
  Sense DNA Copy of miRNA
aagtcagaatcccgccc

SEQ ID NO: 183 - DNA, 22 bp, Artificial
  Sense DNA Copy of miRNA
gcgcgccgctcgccggccgact

SEQ ID NO: 184 - DNA, 24 bp, Artificial
  Sense DNA Copy of miRNA
agtgggggactgcgttcgcgcttt

SEQ ID NO: 185 - DNA, 16 bp, Artificial
  Sense DNA Copy of miRNA
gccgggctccccgggt

SEQ ID NO: 186 - DNA, 21 bp, Artificial
  Sense DNA Copy of miRNA
gccttccccgccggccttccc

SEQ ID NO: 187 - DNA, 17 bp, Artificial
  Sense DNA Copy of miRNA
agcccggggcgcactgg

SEQ ID NO: 188 - DNA, 24 bp, Artificial
  Sense DNA Copy of miRNA
ctccctcggccccgggattcggcg

SEQ ID NO: 189 - DNA, 26 bp, Artificial
  Sense DNA Copy of miRNA
atcgtaggatatcgtaggcacgtgcc

SEQ ID NO: 190 - DNA, 25 bp, Artificial
  Sense DNA Copy of miRNA
cacggcacacagaaacagtaggcac

SEQ ID NO: 191 - DNA, 16 bp, Artificial
  Sense DNA Copy of miRNA
tgggagcgggcgggct

SEQ ID NO: 192 - DNA, 18 bp, Artificial
  Sense DNA Copy of miRNA
acgggtgacggggaatct

SEQ ID NO: 193 - DNA, 23 bp, Artificial
  Sense DNA Copy of miRNA
gaggcccgatcggctgtaggcac

SEQ ID NO: 194 - DNA, 20 bp, Artificial
  Sense DNA Copy of miRNA
ccgacggcgcgacccttgca

SEQ ID NO: 195 - DNA, 16 bp, Artificial
  Sense DNA Copy of miRNA
ggaacgtcgtcgggtc

SEQ ID NO: 196 - DNA, 17 bp, Artificial
  Sense DNA Copy of miRNA
ggccgccgcgtccgtcg

SEQ ID NO: 197 - DNA, 19 bp, Artificial
  Sense DNA Copy of miRNA
cccccgctcccgggaggtc

SEQ ID NO: 198 - DNA, 17 bp, Artificial
  Sense DNA Copy of miRNA
ccggcctcacaccgtcc

SEQ ID NO: 199 - DNA, 16 bp, Artificial
  Sense DNA Copy of miRNA
ccccccggccctcccg

SEQ ID NO: 200 - DNA, 21 bp, Artificial
  Sense DNA Copy of miRNA
cccagccgcggcgcgcgccca

SEQ ID NO: 201 - DNA, 20 bp, Artificial
  Sense DNA Copy of miRNA
agctccacctccccggcgcg

SEQ ID NO: 202 - DNA, 19 bp, Artificial
  Sense DNA Copy of miRNA
tgcttgacgaccggtgcac

SEQ ID NO: 203 - DNA, 27 bp, Artificial
  Sense DNA Copy of miRNA
agtgcccgggccccctataacaggtgc

SEQ ID NO: 204 - DNA, 27 bp, Artificial
  Sense DNA Copy of miRNA
tggcgacacaccccccccgcactaaca

SEQ ID NO: 205 - DNA, 29 bp, Artificial
  Sense DNA Copy of miRNA
ggcggctacgggcctaaaaaggtgctata

SEQ ID NO: 206 - DNA, 19 bp, Artificial
  Sense DNA Copy of miRNA
ggacggtgtgaggccggct

SEQ ID NO: 207 - DNA, 17 bp, Artificial
  Sense DNA Copy of miRNA
cggcggtgggggaggct

SEQ ID NO: 208 - DNA, 25 bp, Artificial
  Sense DNA Copy of miRNA
agcggggaaagaagaccctgttgag

SEQ ID NO: 209 - DNA, 19 bp, Artificial
  Sense DNA Copy of miRNA
gtggggcccgaagcgttct

SEQ ID NO: 210 - DNA, 18 bp, Artificial
  Sense DNA Copy of miRNA
cgggagggccggggggct

SEQ ID NO: 211 - DNA, 17 bp, Artificial
  Sense DNA Copy of miRNA
acgccgtgaccaaagct

SEQ ID NO: 212 - DNA, 18 bp, Artificial
  Sense DNA Copy of miRNA
aggagggccgctgcggct

SEQ ID NO: 213 - DNA, 24 bp, Artificial
  Sense DNA Copy of miRNA
cagtgtgcctcgggctgtaggcac

SEQ ID NO: 214 - DNA, 18 bp, Artificial
  Sense DNA Copy of miRNA
ggcggcggcggcgactct

SEQ ID NO: 215 - DNA, 22 bp, Artificial
  Sense DNA Copy of miRNA
ccgtagcggtcctgtaggcacg

SEQ ID NO: 216 - DNA, 21 bp, Artificial
  Sense DNA Copy of miRNA
ctttgggttccggggggagct

SEQ ID NO: 217 - DNA, 25 bp, Artificial
  Sense DNA Copy of miRNA
acagtgcgccccgggctgtaggcac

SEQ ID NO: 218 - DNA, 17 bp, Artificial
  Sense DNA Copy of miRNA
cctccccgccccccgcc

SEQ ID NO: 219 - DNA, 22 bp, Artificial
  Sense DNA Copy of miRNA
gcgccgctcgccggccgaggct

SEQ ID NO: 220 - DNA, 16 bp, Artificial
  Sense DNA Copy of miRNA
gcgggagaccggggct

SEQ ID NO: 221 - DNA, 16 bp, Artificial
  Sense DNA Copy of miRNA
ggtcgtcgccgccacg

SEQ ID NO: 222 - DNA, 19 bp, Artificial
  Sense DNA Copy of miRNA
agaggtcttggggccgaaa

SEQ ID NO: 223 - DNA, 22 bp, Artificial
  Sense DNA Copy of miRNA
tatgaagcgcttggccttgtca

SEQ ID NO: 224 - DNA, 19 bp, Artificial
  Sense DNA Copy of miRNA
tgcccgggccccctgttca

SEQ ID NO: 225 - DNA, 26 bp, Artificial
  Sense DNA Copy of miRNA
gatgctgcgaggtgtttgcgaagtgc

SEQ ID NO: 226 - DNA, 24 bp, Artificial
  Sense DNA Copy of miRNA
tccttccccgaccggcctttccct

SEQ ID NO: 227 - DNA, 18 bp, Artificial
  Sense DNA Copy of miRNA
gggtgctgtaggctttct

SEQ ID NO: 228 - DNA, 20 bp, Artificial
  Sense DNA Copy of miRNA
tatgaacgcttggcctatca

SEQ ID NO: 229 - DNA, 19 bp, Artificial
  Sense DNA Copy of miRNA
ccccccccacgtttcaagt

SEQ ID NO: 230 - DNA, 18 bp, Artificial
  Sense DNA Copy of miRNA
cgggcgagacgggccggt

SEQ ID NO: 231 - DNA, 19 bp, Artificial
  Sense DNA Copy of miRNA
gggaaggccggcggggaag

SEQ ID NO: 232 - DNA, 23 bp, Artificial
  Sense DNA Copy of miRNA
cgccgaatcccggggccgaggct

SEQ ID NO: 233 - DNA, 20 bp, Artificial
  Sense DNA Copy of miRNA
agcgacgctcagacaggcgt

SEQ ID NO: 234 - DNA, 19 bp, Artificial
  Sense DNA Copy of miRNA
ggtgccttctcttttcaga

SEQ ID NO: 235 - DNA, 18 bp, Artificial
  Sense DNA Copy of miRNA
aaagcgggcgtcgtccct

SEQ ID NO: 236 - DNA, 20 bp, Artificial
  Sense DNA Copy of miRNA
ttgtcaggggtgcgatgcca

SEQ ID NO: 237 - DNA, 24 bp, Artificial
  Sense DNA Copy of miRNA
aggatggccgagctgtaggcacgt

SEQ ID NO: 238 - DNA, 20 bp, Artificial
  Sense DNA Copy of miRNA
aagagggacggccgggggct

SEQ ID NO: 239 - DNA, 23 bp, Artificial
  Sense DNA Copy of miRNA
taaaagcacgtgggcagatatca

SEQ ID NO: 240 - DNA, 17 bp, Artificial
  Sense DNA Copy of miRNA
gtctgagcgtcgcttct

SEQ ID NO: 241 - DNA, 16 bp, Artificial
  Sense DNA Copy of miRNA
agcacctgtaattgga

SEQ ID NO: 242 - DNA, 17 bp, Artificial
  Sense DNA Copy of miRNA
taatgatccttccgcag

SEQ ID NO: 243 - DNA, 22 bp, Artificial
  Sense DNA Copy of miRNA
gcacgcatgaaactgtaaggca

SEQ ID NO: 244 - DNA, 16 bp, Artificial
  Sense DNA Copy of miRNA
ccggggaggtagtgct

SEQ ID NO: 245 - DNA, 20 bp, Artificial
  Sense DNA Copy of miRNA
cgatgtgatttctgcccact

SEQ ID NO: 246 - DNA, 21 bp, Artificial
  Sense DNA Copy of miRNA
agaatcccgcccaggcggaaa

SEQ ID NO: 247 - DNA, 18 bp, Artificial
  Sense DNA Copy of miRNA
actgtaggcaccatcaat

SEQ ID NO: 248 - DNA, 18 bp, Artificial
  Sense DNA Copy of miRNA
aggcccgagccgcctgct

SEQ ID NO: 249 - DNA, 22 bp, Artificial
  Sense DNA Copy of miRNA
aaggagtctaacacgtgcgcct

SEQ ID NO: 250 - DNA, 24 bp, Artificial
  Sense DNA Copy of miRNA
aaatgcctcgtcactgtaggcacg

SEQ ID NO: 251 - DNA, 17 bp, Artificial
  Sense DNA Copy of miRNA
agtggtgcattgaccgg

SEQ ID NO: 252 - DNA, 22 bp, Artificial
  Sense DNA Copy of miRNA
gtgttagagccgtcgcttctag

SEQ ID NO: 253 - DNA, 17 bp, Artificial
  Sense DNA Copy of miRNA
tcgcggcgtattcgtcc

SEQ ID NO: 254 - DNA, 17 bp, Artificial
  Sense DNA Copy of miRNA
ggtatctcccctgccag

SEQ ID NO: 255 - DNA, 18 bp, Artificial
  Sense DNA Copy of miRNA
agaggcccgaccctgctt

SEQ ID NO: 256 - DNA, 26 bp, Artificial
  Sense DNA Copy of miRNA
gctcaacagggtcttctttccccgct

SEQ ID NO: 257 - DNA, 16 bp, Artificial
  Sense DNA Copy of miRNA
tggtgaccccgacgtg

SEQ ID NO: 258 - DNA, 16 bp, Artificial
  Sense DNA Copy of miRNA
attcttttccaccgct

SEQ ID NO: 259 - DNA, 23 bp, Artificial
  Sense DNA Copy of miRNA
atgcacctgaaaactgtaggcac

SEQ ID NO: 260 - DNA, 19 bp, Artificial
  Sense DNA Copy of miRNA
acacccgccgcgggccttc

SEQ ID NO: 261 - DNA, 16 bp, Artificial
  Sense DNA Copy of miRNA
ggggcgaagctaccat

SEQ ID NO: 262 - DNA, 17 bp, Artificial
  Sense DNA Copy of miRNA
atggcacactttgacca

SEQ ID NO: 263 - DNA, 21 bp, Artificial
  Sense DNA Copy of miRNA
tcgattgccgaagcaataatt

SEQ ID NO: 264 - DNA, 20 bp, Artificial
  Complementary Probe of miRNA
gggaaggccggcggggaagg

SEQ ID NO: 265 - DNA, 19 bp, Artificial
  Complementary Probe of miRNA
tgcctacgatacctacgat

SEQ ID NO: 266 - DNA, 17 bp, Artificial
  Complementary Probe of miRNA
ctgtctgagcgtcgctt

SEQ ID NO: 267 - DNA, 22 bp, Artificial
  Complementary Probe of miRNA
gggaaggccgtcggggaaggct

SEQ ID NO: 268 - DNA, 15 bp, Artificial
  Complementary Probe of miRNA
agcccggcgccgcgc

SEQ ID NO: 269 - DNA, 17 bp, Artificial
  Complementary Probe of miRNA
ccggcctcacaccgtcc

SEQ ID NO: 270 - DNA, 16 bp, Artificial
  Complementary Probe of miRNA
agcggggaaagaagac

SEQ ID NO: 271 - DNA, 16 bp, Artificial
  Complementary Probe of miRNA
cccggggcgcactggg

SEQ ID NO: 272 - DNA, 17 bp, Artificial
  Complementary Probe of miRNA
ctgtctgagcgttgctt

SEQ ID NO: 273 - DNA, 19 bp, Artificial
  Complementary Probe of miRNA
gggaaggccggcggggaag

SEQ ID NO: 274 - DNA, 17 bp, Artificial
  Complementary Probe of miRNA
tgtctgagcgtcgctct

SEQ ID NO: 275 - DNA, 28 bp, Artificial
  Complementary Probe of miRNA
gcctgataatgagatccgacacgccggg

SEQ ID NO: 276 - DNA, 17 bp, Artificial
  Complementary Probe of miRNA
gtttcttttcctccgct

SEQ ID NO: 277 - DNA, 24 bp, Artificial
  Complementary Probe of miRNA
tttaattgcctgggttgcgtgggc

SEQ ID NO: 278 - DNA, 19 bp, Artificial
  Complementary Probe of miRNA
tgcaccatacctagtcact

SEQ ID NO: 279 - DNA, 34 bp, Artificial
  Complementary Probe of miRNA
ggcacctgctaatcgtgccgggtgtgcgaggtgc

SEQ ID NO: 280 - DNA, 25 bp, Artificial
  Complementary Probe of miRNA
agtttacatgcgtgcgtgcctgaca

SEQ ID NO: 281 - DNA, 19 bp, Artificial
  Complementary Probe of miRNA
gacacgtctgccctatcaa

SEQ ID NO: 282 - DNA, 19 bp, Artificial
  Complementary Probe of miRNA
tgcacgtggtcgctacagt

SEQ ID NO: 283 - DNA, 18 bp, Artificial
  Complementary Probe of miRNA
cagcccttcactgtctcc

SEQ ID NO: 284 - DNA, 19 bp, Artificial
  Complementary Probe of miRNA
aggacggtggccatggaca

SEQ ID NO: 285 - DNA, 17 bp, Artificial
  Complementary Probe of miRNA
gggcgggattctgactt

SEQ ID NO: 286 - DNA, 22 bp, Artificial
  Complementary Probe of miRNA
agtcggccggcgagcggcgcgc

SEQ ID NO: 287 - DNA, 24 bp, Artificial
  Complementary Probe of miRNA
aaagcgcgaacgcagtcccccact

SEQ ID NO: 288 - DNA, 16 bp, Artificial
  Complementary Probe of miRNA
acccggggagcccggc

SEQ ID NO: 289 - DNA, 21 bp, Artificial
  Complementary Probe of miRNA
gggaaggccggcggggaaggc

SEQ ID NO: 290 - DNA, 17 bp, Artificial
  Complementary Probe of miRNA
ccagtgcgccccgggct

SEQ ID NO: 291 - DNA, 24 bp, Artificial
  Complementary Probe of miRNA
cgccgaatcccggggccgagggag

SEQ ID NO: 292 - DNA, 26 bp, Artificial
  Complementary Probe of miRNA
ggcacgtgcctacgatatcctacgat

SEQ ID NO: 293 - DNA, 25 bp, Artificial
  Complementary Probe of miRNA
gtgcctactgtttctgtgtgccgtg

SEQ ID NO: 294 - DNA, 16 bp, Artificial
  Complementary Probe of miRNA
agcccgcccgctccca

SEQ ID NO: 295 - DNA, 18 bp, Artificial
  Complementary Probe of miRNA
agattccccgtcacccgt

SEQ ID NO: 296 - DNA, 23 bp, Artificial
  Complementary Probe of miRNA
gtgcctacagccgatcgggcctc

SEQ ID NO: 297 - DNA, 20 bp, Artificial
  Complementary Probe of miRNA
tgcaagggtcgcgccgtcgg

SEQ ID NO: 298 - DNA, 16 bp, Artificial
  Complementary Probe of miRNA
gacccgacgacgttcc

SEQ ID NO: 299 - DNA, 17 bp, Artificial
  Complementary Probe of miRNA
cgacggacgcggcggcc

SEQ ID NO: 300 - DNA, 19 bp, Artificial
  Complementary Probe of miRNA
gacctcccgggagcggggg

SEQ ID NO: 301 - DNA, 17 bp, Artificial
  Complementary Probe of miRNA
ggacggtgtgaggccgg

SEQ ID NO: 302 - DNA, 16 bp, Artificial
  Complementary Probe of miRNA
cgggagggccgggggg

SEQ ID NO: 303 - DNA, 21 bp, Artificial
  Complementary Probe of miRNA
tgggcgcgcgccgcggctggg

SEQ ID NO: 304 - DNA, 20 bp, Artificial
  Complementary Probe of miRNA
cgcgccggggaggtggagct

SEQ ID NO: 305 - DNA, 19 bp, Artificial
  Complementary Probe of miRNA
gtgcaccggtcgtcaagca

SEQ ID NO: 306 - DNA, 27 bp, Artificial
  Complementary Probe of miRNA
gcacctgttatagggggcccgggcact

SEQ ID NO: 307 - DNA, 27 bp, Artificial
  Complementary Probe of miRNA
tgttagtgcggggggggtgtgtcgcca

SEQ ID NO: 308 - DNA, 29 bp, Artificial
  Complementary Probe of miRNA
tatagcacctttttaggcccgtagccgcc

SEQ ID NO: 309 - DNA, 19 bp, Artificial
  Complementary Probe of miRNA
agccggcctcacaccgtcc

SEQ ID NO: 310 - DNA, 17 bp, Artificial
  Complementary Probe of miRNA
agcctcccccaccgccg

SEQ ID NO: 311 - DNA, 25 bp, Artificial
  Complementary Probe of miRNA
ctcaacagggtcttctttccccgct

SEQ ID NO: 312 - DNA, 19 bp, Artificial
  Complementary Probe of miRNA
agaacgcttcgggccccac

SEQ ID NO: 313 - DNA, 18 bp, Artificial
  Complementary Probe of miRNA
agccccccggccctcccg

SEQ ID NO: 314 - DNA, 17 bp, Artificial
  Complementary Probe of miRNA
agctttggtcacggcgt

SEQ ID NO: 315 - DNA, 18 bp, Artificial
  Complementary Probe of miRNA
agccgcagcggccctcct

SEQ ID NO: 316 - DNA, 24 bp, Artificial
  Complementary Probe of miRNA
gtgcctacagcccgaggcacactg

SEQ ID NO: 317 - DNA, 18 bp, Artificial
  Complementary Probe of miRNA
agagtcgccgccgccgcc

SEQ ID NO: 318 - DNA, 22 bp, Artificial
  Complementary Probe of miRNA
cgtgcctacaggaccgctacgg

SEQ ID NO: 319 - DNA, 21 bp, Artificial
  Complementary Probe of miRNA
agctccccccggaacccaaag

SEQ ID NO: 320 - DNA, 25 bp, Artificial
  Complementary Probe of miRNA
gtgcctacagcccggggcgcactgt

SEQ ID NO: 321 - DNA, 17 bp, Artificial
  Complementary Probe of miRNA
ggcggggggcggggagg

SEQ ID NO: 322 - DNA, 22 bp, Artificial
  Complementary Probe of miRNA
agcctcggccggcgagcggcgc

SEQ ID NO: 323 - DNA, 16 bp, Artificial
  Complementary Probe of miRNA
agccccggtctcccgc

SEQ ID NO: 324 - DNA, 16 bp, Artificial
  Complementary Probe of miRNA
cgtggcggcgacgacc

SEQ ID NO: 325 - DNA, 19 bp, Artificial
  Complementary Probe of miRNA
tttcggccccaagacctct

SEQ ID NO: 326 - DNA, 22 bp, Artificial
  Complementary Probe of miRNA
tgacaaggccaagcgcttcata

SEQ ID NO: 327 - DNA, 19 bp, Artificial
  Complementary Probe of miRNA
tgaacagggggcccgggca

SEQ ID NO: 328 - DNA, 26 bp, Artificial
  Complementary Probe of miRNA
gcacttcgcaaacacctcgcagcatc

SEQ ID NO: 329 - DNA, 24 bp, Artificial
  Complementary Probe of miRNA
agggaaaggccggtcggggaagga

SEQ ID NO: 330 - DNA, 18 bp, Artificial
  Complementary Probe of miRNA
agaaagcctacagcaccc

SEQ ID NO: 331 - DNA, 20 bp, Artificial
  Complementary Probe of miRNA
tgataggccaagcgttcata

SEQ ID NO: 332 - DNA, 19 bp, Artificial
  Complementary Probe of miRNA
acttgaaacgtgggggggg

SEQ ID NO: 333 - DNA, 18 bp, Artificial
  Complementary Probe of miRNA
accggcccgtctcgcccg

SEQ ID NO: 334 - DNA, 19 bp, Artificial
  Complementary Probe of miRNA
cttccccgccggccttccc

SEQ ID NO: 335 - DNA, 23 bp, Artificial
  Complementary Probe of miRNA
agcctcggccccgggattcggcg

SEQ ID NO: 336 - DNA, 20 bp, Artificial
  Complementary Probe of miRNA
acgcctgtctgagcgtcgct

SEQ ID NO: 337 - DNA, 19 bp, Artificial
  Complementary Probe of miRNA
tctgaaaagagaaggcacc

SEQ ID NO: 338 - DNA, 18 bp, Artificial
  Complementary Probe of miRNA
agggacgacgcccgcttt

SEQ ID NO: 339 - DNA, 20 bp, Artificial
  Complementary Probe of miRNA
tggcatcgcacccctgacaa

SEQ ID NO: 340 - DNA, 24 bp, Artificial
  Complementary Probe of miRNA
acgtgcctacagctcggccatcct

SEQ ID NO: 341 - DNA, 20 bp, Artificial
  Complementary Probe of miRNA
agcccccggccgtccctctt

SEQ ID NO: 342 - DNA, 23 bp, Artificial
  Complementary Probe of miRNA
tgatatctgcccacgtgctttta

SEQ ID NO: 343 - DNA, 17 bp, Artificial
  Complementary Probe of miRNA
agaagcgacgctcagac

SEQ ID NO: 344 - DNA, 16 bp, Artificial
  Complementary Probe of miRNA
tccaattacaggtgct

SEQ ID NO: 345 - DNA, 17 bp, Artificial
  Complementary Probe of miRNA
ctgcggaaggatcatta

SEQ ID NO: 346 - DNA, 22 bp, Artificial
  Complementary Probe of miRNA
tgccttacagtttcatgcgtgc

SEQ ID NO: 347 - DNA, 16 bp, Artificial
  Complementary Probe of miRNA
agcactacctccccgg

SEQ ID NO: 348 - DNA, 20 bp, Artificial
  Complementary Probe of miRNA
agtgggcagaaatcacatcg

SEQ ID NO: 349 - DNA, 21 bp, Artificial
  Complementary Probe of miRNA
tttccgcctgggcgggattct

SEQ ID NO: 350 - DNA, 18 bp, Artificial
  Complementary Probe of miRNA
attgatggtgcctacagt

SEQ ID NO: 351 - DNA, 18 bp, Artificial
  Complementary Probe of miRNA
agcaggcggctcgggcct

SEQ ID NO: 352 - DNA, 22 bp, Artificial
  Complementary Probe of miRNA
aggcgcacgtgttagactcctt

SEQ ID NO: 353 - DNA, 24 bp, Artificial
  Complementary Probe of miRNA
cgtgcctacagtgacgaggcattt

SEQ ID NO: 354 - DNA, 17 bp, Artificial
  Complementary Probe of miRNA
ccggtcaatgcaccact

SEQ ID NO: 355 - DNA, 22 bp, Artificial
  Complementary Probe of miRNA
ctagaagcgacggctctaacac

SEQ ID NO: 356 - DNA, 17 bp, Artificial
  Complementary Probe of miRNA
ggacgaatacgccgcga

SEQ ID NO: 357 - DNA, 17 bp, Artificial
  Complementary Probe of miRNA
ctggcaggggagatacc

SEQ ID NO: 358 - DNA, 18 bp, Artificial
  Complementary Probe of miRNA
aagcagggtcgggcctct

SEQ ID NO: 359 - DNA, 26 bp, Artificial
  Complementary Probe of miRNA
agcggggaaagaagaccctgttgagc

SEQ ID NO: 360 - DNA, 16 bp, Artificial
  Complementary Probe of miRNA
cacgtcggggtcacca

SEQ ID NO: 361 - DNA, 16 bp, Artificial
  Complementary Probe of miRNA
agcggtggaaaagaat

SEQ ID NO: 362 - DNA, 23 bp, Artificial
  Complementary Probe of miRNA
gtgcctacagttttcaggtgcat

SEQ ID NO: 363 - DNA, 19 bp, Artificial
  Complementary Probe of miRNA
gaaggcccgcggcgggtgt

SEQ ID NO: 364 - DNA, 16 bp, Artificial
  Complementary Probe of miRNA
atggtagcttcgcccc

SEQ ID NO: 365 - DNA, 17 bp, Artificial
  Complementary Probe of miRNA
tggtcaaagtgtgccat

SEQ ID NO: 366 - DNA, 21 bp, Artificial
  Complementary Probe of miRNA
aattattgcttcggcaatcga

SEQ ID NO: 367 - DNA, 21 bp, Artificial
  Oligonucleotide
tgcattcctcgtcactgaatc

SEQ ID NO: 368 - DNA, 20 bp, Artificial
  Oligonucleotide
gtcattgcctagtcatcaag

SEQ ID NO: 369 - DNA, 21 bp, Artificial
  Oligonucleotide
gattcagtgacgaggaatgca

SEQ ID NO: 370 - DNA, 20 bp, Artificial
  Oligonucleotide
cttgatgactaggcaatgac

SEQ ID NO: 371 - DNA, 22 bp, Artificial
  Oligonucleotide
cggtactgactgaaacttcagt

SEQ ID NO: 372 - DNA, 22 bp, Artificial
  Oligonucleotide
gcaaaccgctactacgctaggc

SEQ ID NO: 373 - DNA, 22 bp, Artificial
  Oligonucleotide
actgaagtttcagtcagtaccg

SEQ ID NO: 374 - DNA, 22 bp, Artificial
  Oligonucleotide
gcctagcgtagtagcggtttgc

SEQ ID NO: 375 - DNA, 22 bp, Artificial
  Oligonucleotide
ctatacgccacggatcaccact

SEQ ID NO: 376 - DNA, 23 bp, Artificial
  Oligonucleotide
gatggggcaatgcaatcggcata

SEQ ID NO: 377 - DNA, 23 bp, Artificial
  Oligonucleotide
atcgattttccgatcgtcgatgc

SEQ ID NO: 378 - DNA, 21 bp, Artificial
  Oligonucleotide
aggccttttcctgcatggcta

SEQ ID NO: 379 - DNA, 23 bp, Artificial
  Oligonucleotide
ggataatactcattggctatgcc

SEQ ID NO: 380 - DNA, 22 bp, Artificial
  Oligonucleotide
ataaataaatgctactgcatcg

SEQ ID NO: 381 - DNA, 23 bp, Artificial
  Oligonucleotide
ctgatcgatgctatgcaaatttt

SEQ ID NO: 382 - DNA, 23 bp, Artificial
  Oligonucleotide
tttgtcaagctcatttcctggta

SEQ ID NO: 383 - DNA, 23 bp, Artificial
  Oligonucleotide
taccaggaaatgagcttgacaaa

SEQ ID NO: 384 - DNA, 22 bp, Artificial
  Oligonucleotide
aaaacctaacttgcgcagaaaa

SEQ ID NO: 385 - DNA, 22 bp, Artificial
  Oligonucleotide
ttttctgcgcaagttaggtttt

SEQ ID NO: 386 - DNA, 22 bp, Artificial
  Oligonucleotide
ccttgttacgacttttacttcc

SEQ ID NO: 387 - DNA, 20 bp, Artificial
  Oligonucleotide
gaccgtcttctcagcgctcc

SEQ ID NO: 388 - DNA, 22 bp, Artificial
  Oligonucleotide
ggaagtaaaagtcgtaacaagg

SEQ ID NO: 389 - DNA, 20 bp, Artificial
  Oligonucleotide
ggagcgctgagaagacggtc